(19) United States
(12) Patent Application Publication
(10) Pub. No.: US 2026/0362382 A1
(43) Pub. Date: Nov. 12, 2026

(54) Information Reporting Method

(71) Applicant: VIVO MOBILE COMMUNICATION CO., LTD., Dongguan (CN)

(72) Inventors: Sihan Cheng, Dongguan (CN); Weiwei Chong, Dongguan (CN)

(21) Appl. No.: 19/721,040

(22) Filed: Jun. 26, 2026

Related U.S. Application Data
(63) Continuation of application No. PCT/CN2024/141532, filed on Dec. 23, 2024.

(30) Foreign Application Priority Data
Dec. 29, 2023 (CN) 202311857498.9

(51) Int. Cl. H04W 64/00; G06N 5/04

(52) U.S. Cl. CPC H04W 64/00; G06N 5/04

(57) ABSTRACT

An information reporting method includes: A first communication device receives a first message from a second communication device. The first message includes first related information corresponding to the second communication device. The first related information is used to perform AI positioning via the second communication device.

### CROSS-REFERENCE TO RELATED APPLICATIONS

This application is a Bypass Continuation Application of International Patent Application No. PCT/CN2024/141532 filed Dec. 23, 2024, and claims priority to Chinese Patent Application No. 202311857498.9 filed Dec. 29, 2023, the disclosures of which are hereby incorporated by reference in their entireties.

### BACKGROUND OF THE INVENTION

### Field of the Invention

This application pertains to the field of communication technologies, and in particular, relates to an information reporting method.

### Description of Related Art

Currently, artificial intelligence (AI) technologies have been applied to a plurality of scenarios, including positioning scenarios. In an AI positioning scenario, a core network device may indicate a communication device (for example, a terminal or an access network device) to perform AI positioning on the terminal in a predetermined positioning manner, so that the communication device can obtain positioning data and report the positioning data to the core network device, and the core network device can determine location information of the terminal based on the positioning data.

### SUMMARY OF THE INVENTION

According to a first aspect, an information reporting method is provided and is performed by a first communication device, and the method includes: The first communication device receives a first message from a second communication device. The first message includes first related information corresponding to the second communication device. The first related information is used to perform AI positioning via the second communication device.

According to a second aspect, an information reporting method is provided and is performed by a second communication device, and the method includes: The second communication device sends a first message to a first communication device. The first message includes first related information corresponding to the second communication device. The first related information is used to perform AI positioning via the second communication device.

According to a third aspect, an information reporting method is provided and is performed by a third communication device, and the method includes: The third communication device receives a second message from a first communication device, where the second message includes first related information corresponding to a second communication device; and the third communication device performs AI positioning via the second communication device based on the first related information.

According to a fourth aspect, an information reporting apparatus is provided, the information reporting apparatus includes a first information reporting apparatus, and the first information reporting apparatus includes: a receiving module, configured to receive a first message from a second information reporting apparatus. The first message includes first related information corresponding to the second information reporting apparatus. The first related information is used to perform AI positioning via the second information reporting apparatus.

According to a fifth aspect, an information reporting apparatus is provided, the information reporting apparatus includes a second information reporting apparatus, and the second information reporting apparatus includes: a sending module, configured to send a first message to a first information reporting apparatus. The first message includes first related information corresponding to the second information reporting apparatus. The first related information is used to perform AI positioning via the second information reporting apparatus.

According to a sixth aspect, an information reporting apparatus is provided, the information reporting apparatus includes a third information reporting apparatus, and the third information reporting apparatus includes: a receiving module, configured to receive a second message from a first information reporting apparatus, where the second message includes first related information corresponding to a second information reporting apparatus; and a positioning module, configured to perform, based on the first related information received by the receiving module, AI positioning via the second information reporting apparatus.

According to a seventh aspect, a network side device is provided. The network side device includes a processor and a memory. The memory stores a program or instructions executable on the processor. When the program or the instructions are executed by the processor, steps of the method according to the first aspect are implemented, or steps of the method according to the second aspect are implemented, or steps of the method according to third aspect are implemented.

According to an eighth aspect, a network side device is provided, including a processor and a communication interface. The communication interface is configured to receive a first message from a second communication device. The first message includes first related information corresponding to the second communication device. The first related information is used to perform AI positioning via the second communication device. Alternatively, the communication interface is configured to send a first message to a first communication device. The first message includes first related information corresponding to the second communication device. The first related information is used to perform AI positioning via the second communication device. Alternatively, the communication interface is configured to receive a second message from the first communication device. The second message includes first related information corresponding to the second communication device. The processor is configured to perform AI positioning via the second communication device based on the first related information.

According to a ninth aspect, a terminal is provided. The terminal includes a processor and a memory. The memory stores a program or instructions executable on the processor. When the program or the instructions are executed by the processor, steps of the method according to the second aspect are implemented.

According to a tenth aspect, a terminal is provided, including a processor and a communication interface. The communication interface is configured to send a first message to a first communication device. The first message includes first related information corresponding to a second communication device. The first related information is used to perform AI positioning via the second communication device.

According to an eleventh aspect, a non-transitory readable storage medium is provided. The non-transitory readable storage medium stores a program or instructions. When the program or the instructions are executed by a processor, steps of the method according to the first aspect are implemented, or steps of the method according to the second aspect are implemented, or steps of the method according to third aspect are implemented.

According to a twelfth aspect, a wireless communication system is provided, including a first communication device, a second communication device, and a third communication device. The first communication device may be configured to perform steps of the method according to the first aspect, the second communication device may be configured to perform steps of the method according to the second aspect, and the third communication device may be configured to perform steps of the method according to the third aspect.

According to a thirteenth aspect, a chip is provided. The chip includes a processor and a communication interface. The communication interface is coupled to the processor. The processor is configured to run a program or instructions, to implement steps of the method according to the first aspect, or implement steps of the method according to the second aspect, or implement steps of the method according to the third aspect.

According to a fourteenth aspect, a computer program/program product is provided. The computer program/program product is stored in a non-transitory storage medium, and the program/program product is executed by at least one processor to implement steps of the method according to the first aspect, or implement steps of the method according to the second aspect, or implement steps of the method according to the third aspect.

### BRIEF DESCRIPTION OF THE DRAWINGS

FIG. 1 is a schematic diagram of signaling interaction of a location service procedure in a related technology;

FIG. 2 is a block diagram of a wireless communication system according to an embodiment of this application;

FIG. 3 is a schematic flowchart 1 of an information reporting method according to an embodiment of this application;

FIG. 4 is a schematic flowchart 2 of an information reporting method according to an embodiment of this application;

FIG. 5 is a schematic flowchart 3 of an information reporting method according to an embodiment of this application;

FIG. 6 is a schematic diagram 1 of signaling interaction of an information reporting method according to an embodiment of this application;

FIG. 7 is a schematic diagram 2 of signaling interaction of an information reporting method according to an embodiment of this application;

FIG. 8 is a schematic diagram 3 of signaling interaction of an information reporting method according to an embodiment of this application;

FIG. 9 is a schematic diagram 4 of signaling interaction of an information reporting method according to an embodiment of this application;

FIG. 10 is a schematic diagram 5 of signaling interaction of an information reporting method according to an embodiment of this application;

FIG. 11 is a schematic diagram of a structure of a first information reporting method according to an embodiment of this application;

FIG. 12 is a schematic diagram of a structure of a second information reporting method according to an embodiment of this application;

FIG. 13 is a schematic diagram of a structure of a third information reporting method according to an embodiment of this application;

FIG. 14 is a schematic diagram of a hardware structure of a communication device according to an embodiment of this application;

FIG. 15 is a schematic diagram of a hardware structure of a terminal according to an embodiment of this application;

FIG. 16 is a schematic diagram 1 of a hardware structure of a network side device according to an embodiment of this application; and

FIG. 17 is a schematic diagram 2 of a hardware structure of a network side device according to an embodiment of this application.

### DESCRIPTION OF THE INVENTION

The following clearly describes the technical solutions in embodiments of this application with reference to the accompanying drawings in embodiments of this application. Apparently, the described embodiments are a part but not all of embodiments of this application. All other embodiments obtained by a person of ordinary skill in the art based on embodiments of this application shall fall within the protection scope of this application.

Terms related to embodiments of this application are described below.

1. Location service (LCS)

Usually, the location service is performed and provided by an access mobility management function (AMF) network element and a location management function (LMF) network element in a core network device. An LCS message is exchanged between a terminal and a LCS client or an application function (AF) network element. A typical procedure is a mobile terminated location request (MT-LR) procedure.

The MT-LR procedure is initiated by an external third-party application (LCS client) or by the AF network element via a network exposure function (NEF) network element, and finally obtains location information of the terminal via network elements such as a gateway mobile location center (GMLC) network element, the AMF network element, and the LMF network element.

However, there may be a case in which the communication device cannot perform AI positioning on the terminal in the predetermined positioning manner, and in this case, the communication device may not obtain positioning data and report the positioning data to the core network device. Therefore, the core network device may not determine the location information of the terminal, which causes an AI positioning failure. Consequently, a success rate of AI positioning is low.

2. Location service procedure

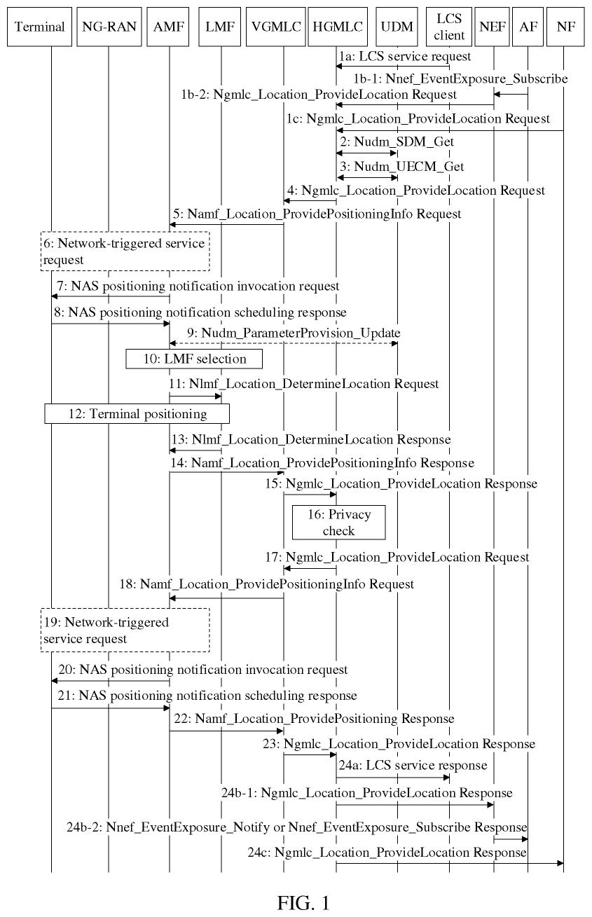

FIG. 1 is a schematic diagram of signaling interaction of the location service procedure in a related technology. As shown in FIG. 1, the location service procedure may include the following steps.

Step 1a (1b -1, 1b-2, or 1-c): An LCS client, a network function (NF) network element, or an AF network element (via an NEF network element) sends a request to a(H) GMLC network element to obtain a location and a velocity (optional) for a terminal. The velocity may be identified by a generic public subscription identifier (GPSI) or a subscription permanent identifier (SUPI). Step 1c is used as an example. The NF network element invokes a Ngmlc_Location_ProvideLocation service operation toward the (H)GMLC.

Step 2: The (H)GMLC invokes a Nudm_SDM_Get service operation toward a unified data manager (UDM) network element of the terminal to obtain privacy settings of the terminal identified by the GPSI or the SUPI of the terminal. The UDM network element returns the privacy settings of the terminal. The (H)GMLC checks an LCS privacy profile of the terminal.

Step 5: The (H)GMLC or a VGMLC invokes a Namf_Location_ProvidePositioningInfo service operation toward the AMF network element to request a current location of the terminal. The service operation includes the SUPI and a client type, and may include a required LCS quality of service (QoS), supported geographic area description (GAD) shapes, scheduled location time, a service type, and other attribute information received or determined in step 1.

Steps 10 to step 13: The AMF network element selects an LMF network element based on available information as defined in a related standard protocol or based on a local configuration of the AMF network element. LMF network element selection takes an access network device 5G-AN currently serving the terminal into account. The selection may use a network repository function (NRF) network element query.

The AMF network element invokes a Nlmf_Location_DetermineLocation service operation toward the LMF network element to request the current location of the terminal.

The LMF network element performs one or more of positioning procedures described in a related standard protocol. During this step, the LMF network element may use a Namf_Communication_N1N2MessageTransfer service operation to request transfer of a positioning-related N1 message to the terminal or transfer of a network positioning message to a serving NG-RAN node (gNB or NG-eNB) for the terminal. The LMF network element needs to determine a geographical location and may optionally determine the location in local coordinates.

Step 22: The AMF network element returns a Namf_Location_ProvidePositioningInfo response toward the (V)GMLC (or the HGMLC for roaming when an NL3 reference point is not supported) with an indication of a result of notification.

Step 24a (24b-1, 24b-2, or 24c): If the terminal is allowed to be located by the LCS client, the NF network element, or the AF network element, the (H)GMLC sends a location service response to the LCS client, the NF network element, or the AF network element (via the NEF network element).

3. Other terms

Terms “first” and “second” in this application are used to distinguish between similar objects, and do not need to be used to describe a specific order or sequence. It should be understood that, the terms used in such a way are interchangeable in proper circumstances, so that embodiments of this application can be implemented in an order other than the order illustrated or described herein. Objects classified by “first” and “second” are usually of a same type, and a quantity of objects is not limited. For example, there may be one or more first objects. In addition, “or” in this application indicates at least one of connected objects. For example, “A or B” covers three scenarios, that is, a scenario 1: including A but not B; a scenario 2: including B but not A; and a scenario 3: including both A and B. The character “/” usually indicates an “or” relationship between associated objects.

A term “indication” of this application may be either a direct indication (or an explicit indication) or an indirect indication (or an implicit indication). The direct indication may be understood as that, in a sent indication, a sender explicitly notifies a receiver of content such as information, an operation that needs to be performed, or a request result. The indirect indication may be understood as that the receiver determines corresponding information based on the indication sent by the sender, or determines, based on a determining result, an operation that needs to be performed, a request result, or the like.

Terms “at least one (item)”, “at least one”, and the like of this application is any one, any two, or any combination of two or more among included objects. For example, at least one (item) of a, b, or c may indicate a, b, c, a and b, a and c, b and c, or a, b, and c, where a, b, and c may be singular or may be plural. Similarly, “at least two (items)” are two or more, and meanings expressed by “at least two (items)” are similar to those of “at least one (item)”.

It should be noted that technologies described in embodiments of this application are not limited to a Long Term Evolution (LTE)/LTE-Advanced (LTE-A) system, and may be applied to other wireless communication systems such as code division multiple access (CDMA), time division multiple access (TDMA), frequency division multiple access (FDMA), orthogonal frequency division multiple access (OFDMA), single-carrier frequency division multiple access (SC-FDMA), or other systems. The terms “system” and “network” in embodiments of this application may be used interchangeably. The technologies described can be applied to both the systems and the radio technologies mentioned above as well as to other systems and radio technologies. A new radio (NR) system is described in the following descriptions for illustrative purposes, and the NR terminology is used in most of the following descriptions, although these technologies may also be applied to systems other than the NR system, such as a 6-th generation (6G) communication system.

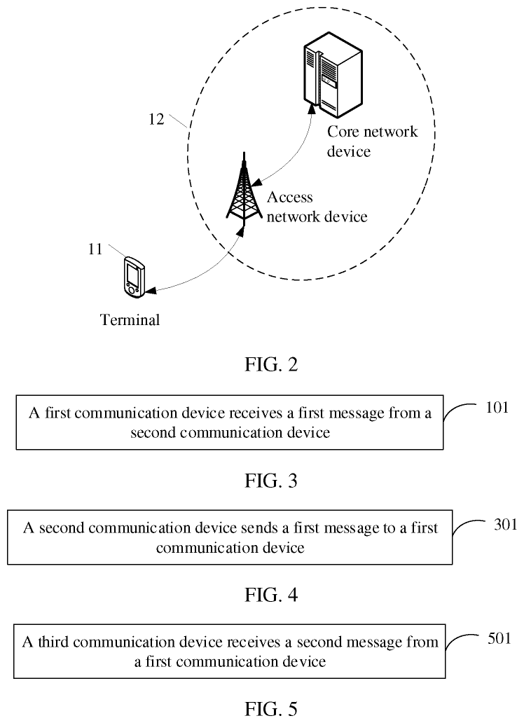

FIG. 2 is a block diagram of a wireless communication system to which an embodiment of this application may be applied. The wireless communication system includes a terminal 11 and a network side device 12. The terminal 11 may be a terminal-side device such as a mobile phone, a tablet computer (Tablet Personal Computer), a laptop computer, a notebook computer, a personal digital assistant (PDA), a palmtop computer, a netbook, an ultra-mobile personal computer (UMPC), a mobile internet device (MID), an augmented reality (AR) device, a virtual reality (VR) device, a robot, a wearable device, a flight vehicle, a vehicle-mounted device (VUE), a ship-mounted device, pedestrian terminal (PUE), a smart household (a household device having a wireless communication function, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bracelet, a smart hand chain, a smart ring, a smart necklace, a smart anklet, a smart ankle chain), a smart wristband, smart clothing, and the like. The vehicle-mounted device may also be referred to as a vehicle-mounted terminal, a vehicle-mounted controller, a vehicle-mounted module, a vehicle-mounted component, a vehicle-mounted chip, a vehicle-mounted unit, or the like. It should be noted that a type of the terminal 11 is not limited in embodiments of this application. The network side device 12 may include an access network device or a core network device. The access network device may also be referred to as a radio access network (RAN) device, a radio access network function, or a radio access network unit. The access network device may include a base station, OAM (Operation Administration and Maintenance, operation and maintenance management), a gateway, a wireless local area network (WLAN) access point (AS), a Wireless Fidelity (Wi-Fi) node, or the like. The base station may be referred to as a NodeB (NB), an evolved NodeB (eNB), a next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, transmission reception point (TRP), or another appropriate term in the field, as long as same technical effect is achieved. The base station is not limited to a specific technical term. It should be noted that, in embodiments of this application, only a base station in an NR system is used as an example for description, and a type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function unit (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), or the like. It should be noted that, in the embodiments of this application, only a core network device in an NR system is used as an example for description, and a type of the core network device is not limited.

With reference to the accompanying drawings, the following describes in detail an information reporting method and apparatus, and a related product provided in embodiments of this application by using some embodiments and application scenarios thereof.

FIG. 3 is a schematic flowchart of the information reporting method according to an embodiment of this application. As shown in FIG. 3, the information reporting method provided in this embodiment of this application may include the following step 101.

Step 101: A first communication device receives a first message from a second communication device.

In some embodiments of this application, the first communication device may be a core network device, for example, an access and mobility management function (AMF) network element, and the second communication device may include at least one of the following: a terminal or an access network device.

In some embodiments of this application, when the second communication device registers with the first communication device, the first communication device may receive the first message from the second communication device. Alternatively, when preparing to perform AI positioning via the second communication device, the first communication device may request first related information from the second communication device, so that the first communication device may receive the first message from the second communication device. Alternatively, among other interactions between the second communication device and the first communication device other than registration or AI positioning, the first communication device may receive the first message from the second communication device.

In a case, when registering with the first communication device, the second communication device sends the first message to the first communication device. In this case, optionally, the first message is a registration message.

For example, when the second communication device is the terminal, the terminal may first send the first message to the access network device (for example, a registration message Registration Request), so that the access network device may determine a proper core network device as the first communication device based on a temporary subscriber identifier or a slice included in the Registration Request, and the access network device may forward the Registration Request to the first communication device. The first communication device may receive the Registration Request (that is, the first message).

In another case, when the first communication device prepares to trigger AI positioning performed via the second communication device, the second communication device sends the first message to the first communication device based on a request of the first communication device. Optionally, before step 101, the information reporting method provided in this embodiment of this application may further include the following step 201.

Step 201: The first communication device sends a seventh message to the second communication device.

In this embodiment of this application, the seventh message is used to request the first related information.

In some embodiments of this application, the seventh message may be any one of the following: a long term evolution positioning protocol (LPP) message, a new radio positioning protocol (NRPP) message, and a non-access stratum (NAS) message.

In some embodiments of this application, after the first communication device sends the seventh message to the second communication device, the second communication device may obtain the first related information based on the seventh message, and send the first message including the first related information to the first communication device. Therefore, the first communication device may receive the first message from the second communication device.

It may be learned from this that the first communication device may request the first related information from the second communication device, so that the second communication device may report the first related information to the first communication device based on the request. Therefore, a case in which the first communication device has learned the first related information, but the second communication device repeatedly reports the first related information may be avoided, which can save transmission resources for repeatedly reporting the first related information.

In this embodiment of this application, the first message includes the first related information corresponding to the second communication device, and the first related information is used to perform AI positioning via the second communication device.

It should be noted that the first related information may be applicable to determining a positioning manner related to the second communication device, for example, AI positioning and an AI positioning manner.

In some embodiments of this application, the first related information includes at least one of the following: capability information, where the capability information is used to indicate an AI positioning capability corresponding to the second communication device; or expected information, where the expected information is used to indicate a related manner expected by the second communication device for performing AI positioning.

The capability information may be understood as information about an AI positioning capability supported by the second communication device. The expected information may be understood as information that the second communication device expects to use AI positioning, for example, in which case AI positioning is used.

It may be learned from this that the first related information reported by the second communication device may include the capability information indicating the AI positioning capability that corresponds to the second communication device and/or AI positioning information expected by the second communication device, so that in a subsequent AI positioning process, another communication device may accurately determine whether AI positioning can be performed via the second communication device, and/or a manner suitable for performing AI positioning via the second communication device. Therefore, this can reduce a case of an AI positioning failure, and improve efficiency of interaction between the first communication device and the second communication device, and improve positioning accuracy by using an AI positioning method.

In some embodiments of this application, the capability information includes at least one of the following: first indication information, where the first indication information is used to indicate that the second communication device supports AI positioning; an AI positioning manner supported by the second communication device; an input data type supported by the second communication device; an output data type supported by the second communication device; a data type that the second communication device supports for transmission; or a data type of measurement data supported by the second communication device.

Optionally, when the second communication device supports AI positioning, the capability information may include the first indication information. When the second communication device does not support AI positioning, the capability information may not include the first indication information.

Optionally, the AI positioning manner includes at least one of the following: a first manner, where the first manner is a manner in which a terminal generates positioning result data by using an AI positioning model; a second manner, where the second manner is a manner in which the terminal generates positioning intermediate data by using the AI positioning model; a third manner, where the third manner is a manner in which a third communication device generates positioning result data by using the AI positioning model; a fourth manner, where the fourth manner is a manner in which an access network device generates positioning intermediate data by using an AI positioning model; or a fifth manner, where the fifth manner is a manner in which a third communication device generates positioning result data by using the AI positioning model.

The positioning result data may be location information (Location) obtained by performing AI positioning. The positioning intermediate data may be intermediate feature data (Intermediate features) generated by performing AI positioning, and the intermediate feature data needs to be processed to obtain the location information (Location).

For example, in the first manner, the AI positioning model is set in the terminal. In this way, the access network device may send a positioning reference signal (PRS) to the terminal, so that the terminal may measure the PRS to obtain measurement data. The terminal may input the measurement data to the AI positioning model to obtain positioning intermediate data output by the AI positioning model. The AI positioning model may be an A-AIML model, that is, an Assist AIML model, is an auxiliary AIML model, or a model that can output intermediate data. The terminal may process the positioning intermediate data to generate the positioning result data. Alternatively, the terminal may input the measurement data to the AI positioning model to obtain positioning result data output by the AI positioning model. The AI positioning model may be a D-AIML model, that is, a Direct AIML model, or a model that can output the positioning result data. It should be noted that, in an actual application process, the first manner may also be referred to as another name, for example, case 1.

For example, in the second manner, the AI positioning model is set in the terminal. In this way, the access network device may send a PRS to the terminal, so that the terminal may measure the PRS to obtain measurement data. The terminal may input the measurement data into the AI positioning model to obtain positioning intermediate data output by the AI positioning model. The AI positioning model may be an A-AIML model. The terminal may send the positioning intermediate data to another communication device (for example, the third communication device), so that the third communication device may process the positioning intermediate data to generate positioning result data. It should be noted that, in an actual application process, the second manner may also be referred to as another name, for example, case2a.

For example, in the third manner, the AI positioning model is set in the third communication device. In this way, the access network device may send a PRS to the terminal, so that the terminal may measure the PRS to obtain measurement data. The terminal may send the measurement data to the third communication device, so that the third communication device may input the measurement data to the AI positioning model to obtain positioning intermediate data output by the AI positioning model. The AI positioning model may be an A-AIML model. The third communication device may process the positioning intermediate data to generate positioning result data. Alternatively, the third communication device may input the measurement data to the AI positioning model to obtain positioning result data output by the AI positioning model. The AI positioning model may be a D-AIML model. It should be noted that, in an actual application process, the third manner may also be referred to as another name, for example, case2b.

For example, in the fourth manner, the AI positioning model is set in the access network device. In this way, the terminal may send a sounding reference signal (SRS) to the access network device, so that the access network device may measure the SRS to obtain measurement data. The access network device may input the measurement data into the AI positioning model to obtain positioning intermediate data output by the AI positioning model. The AI positioning model may be an A-AIML model. The access network device may process the positioning intermediate data to generate positioning result data. Alternatively, the access network device may input the measurement data to the AI positioning model to obtain positioning result data output by the AI positioning model. The AI positioning model may be a D-AIML model. It should be noted that, in an actual application process, the fourth manner may also be referred to as another name, for example, case3a.

For example, in the fifth manner, the AI positioning model is set in the third communication device. In this way, the terminal may send a SRS to the access network device, so that the access network device may measure the SRS to obtain measurement data. The access network device may send the measurement data to the third communication device, so that the third communication device may input the measurement data to the AI positioning model to obtain positioning intermediate data output by the AI positioning model. The AI positioning model may be an A-AIML model. The third communication device may process the positioning intermediate data to generate positioning result data. Alternatively, the third communication device may input the measurement data to the AI positioning model to obtain positioning result data output by the AI positioning model. The AI positioning model may be a D-AIML model. It should be noted that, in an actual application process, the fifth manner may also be referred to as another name, for example, case3b.

It may be learned from this that the AI positioning manner may include a plurality of different manners, and in subsequent steps, another communication device may select, based on a requirement, an AI positioning manner in which AI positioning is performed via the second communication device. Therefore, flexibility of performing AI positioning via the second communication device can be improved.

Optionally, when the second communication device includes the terminal, the AI positioning manner supported by the second communication device may include at least one of the following: the first manner, the second manner, or the third manner. When the second communication device includes the access network device, the AI positioning manner supported by the second communication device may include at least one of the following: the fourth manner or the fifth manner.

Optionally, a quantity of input data types supported by the second communication device may be at least one, and each input data type is a type of data that needs to be input in one AI positioning manner. The input data type supported by the second communication device may include at least one of the following: a channel impulse response (CIR), a power delay profile (PDP), time of arrival (TOA), a reference signal receiving power path (RSRPP), a path phase (Path Phase), or the like.

When the second communication device includes the terminal, the input data type supported by the second communication device may include at least one of the following: the CIR, the PDP, the TOA, or the like. When the second communication device includes the access network device, the input data type supported by the second communication device may include at least one of the following: the RSRPP, the TOA, the path phase, or the like.

Optionally, the output data type supported by the second communication device may include at least one of the following: positioning intermediate data, positioning result data, measurement data, or the like.

Optionally, the data type that the second communication device supports for transmission is used to indicate a data type that can be reported by the second communication device, that is, a data type that can be sent by the second communication device to a core network side (for example, the third communication device) in a positioning interaction process.

Optionally, the data type of the measurement data supported by the second communication device may include at least one of the following: a CIR, a PDP, a reference signal receiving power (RSRP), a RSRPP, or a reference signal time difference (RSTD).

It may be learned from this that this embodiment of this application specifies the content of the AI positioning capability that corresponds to the second communication device. In a subsequent step, another communication device may clearly learn, based on the content, the AI positioning capability that corresponds to the second communication device, to accurately determine, based on the AI positioning capability, whether to perform AI positioning via the second communication device, and/or a manner suitable for performing AI positioning via the second communication device is suitable. Therefore, this can reduce a case of an AI positioning failure.

In some embodiments of this application, the expected information includes at least one of the following:
an AI positioning manner expected by the second communication device;
an input data type expected by the second communication device;
an output data type expected by the second communication device;
a data type that the second communication device expects to send; or
a data type of measurement data expected by the second communication device.

It should be noted that for descriptions of the AI positioning manner, the input data type, the output data type, the sent data type, and the data type of measurement data, refer to descriptions in the foregoing embodiment. Details are not described herein again in this embodiment of this application.

It should be noted that the foregoing expected information may alternatively be understood as willingness information, and all is used to describe a condition and the like, expected by the second communication device, to be used in AI positioning.

It may be learned from this that this embodiment of this application specifies the content of a related manner that the second communication device expects for performing AI positioning. In this way, in a subsequent step, another device may clearly learn, based on the content, a related manner that the second communication device expects for performing AI positioning, to accurately determine, based on the related manner, a related manner expected by the second communication device. Therefore, the second communication device may perform AI positioning in the expected related manner.

According to an information reporting method provided in an embodiment of this application, the first communication device may receive the first message from the second communication device. The first message includes the first related information corresponding to the second communication device, and the first related information is used to perform AI positioning via the second communication device. The first communication device may receive, from the second communication device, the first related information used to perform AI positioning via the second communication device. In this way, when AI positioning is performed via the second communication device, the first communication device may indicate another communication device to determine, based on the first related information, a positioning manner for performing AI positioning via the second communication device, to determine a positioning manner in which the second communication device may perform AI positioning instead of using a predetermined positioning manner. Therefore, this can reduce a probability that the second communication device cannot perform AI positioning in a positioning manner, so that probability of a case in which the first communication device cannot determine location information of a terminal can be reduced, and a probability of a case in which AI positioning fails to be performed can be reduced. In this way, a success rate of AI positioning can be improved.

Certainly, after receiving the first related information, the first communication device may alternatively store the first related information. Therefore, when the first related information is required to be used, the first communication device may quickly obtain the first related information. The following provides an example for description.

In some embodiments of this application, after the foregoing step 102, the information reporting method provided in this embodiment of this application may further include the following step 202 or step 203.

Step 202: The first communication device stores the first related information.

In some embodiments of this application, after receiving the first message, the first communication device may obtain the first related information from the first message, and store the first related information in the first communication device.

Optionally, the first communication device may store the first related information and a device identifier of the second communication device in the first communication device, so that in a subsequent step, the first communication device may quickly find the first related information based on the device identifier.

It may be learned from this that the first communication device may directly store the first related information in the first communication device, and in a subsequent step, the first communication device may quickly obtain the first related information from the first communication device without performing signaling interaction with another communication device. Therefore, efficiency of obtaining the first related information can be improved.

Step 203: The first communication device sends a fourth message to a fourth communication device.

In this embodiment of this application, the fourth message includes the first related information.

In some embodiments of this application, the fourth communication device may be a core network device, or a network element having a storage function, for example, a unified data management (UDM) network element.

In some embodiments of this application, the fourth message is used to request the fourth communication device to store the first related information.

In some embodiments of this application, the fourth message may further include the device identifier of the second communication device. Therefore, when receiving the fourth message, the fourth communication device may store the first related information and the device identifier of the second communication device in the fourth communication device. Therefore, in a subsequent step, the first communication device may send a request message to the fourth communication device, and the request message may include the device identifier, so that the fourth communication device can quickly find the first related information based on the device identifier.

In some embodiments of this application, after the fourth communication device stores the first related information, the first communication device may receive a response message from the fourth communication device, and the response message is used to indicate a storage result, for example, indicate that the fourth communication device has successfully stored the first related information. Therefore, the first communication device may send an indication message to the second communication device based on the response message, and the indication message is used to indicate that the first related information has been successfully stored.

It may be learned from this that the first communication device may alternatively send the first related information to the fourth communication device, so that the fourth communication device may store the first related information, and the first communication device does not need to store the first related information in the first communication device. Therefore, storage space for storing the first related information in the first communication device can be saved.

In some embodiments of this application, when the first related information needs to be used, if the first communication device stores the first related information in the first communication device, the first communication device may directly obtain the first related information from the first communication device.

Optionally, when the first communication device receives a positioning-related task request (the positioning-related task request is used to request to obtain location information of the terminal) from another communication device, it may be determined that the first related information needs to be used. In this case, the first communication device may directly obtain the first related information from the first communication device.

In some embodiments of this application, when the first related information needs to be used, if the first communication device indicates the fourth communication device to store the first related information, the first communication device may alternatively request the first related information from the fourth communication device. Optionally, after step 203, the information reporting method provided in this embodiment of this application may further include the following step 204 and step 205.

Step 204: The first communication device sends a fifth message to the fourth communication device.

In this embodiment of this application, the fifth message is used to request the first related information.

In some embodiments of this application, when the first communication device receives a positioning-related task request (the positioning-related task request is used to request to obtain location information of the terminal) from another communication device, it may be determined that the first related information needs to be used. In this case, the first communication device may send the fifth message to the fourth communication device.

In some embodiments of this application, the fifth message includes the device identifier of the second communication device, so that the fourth communication device may determine, based on the device identifier, the first related information from information stored in the fourth communication device.

Step 205: A first communication device receives a sixth message from the fourth communication device.

In this embodiment of this application, the sixth message includes the first related information.

It may be learned from this that when the first related information needs to be used, the first communication device may directly request the first related information from the fourth communication device to obtain the first related information from the fourth communication device, and does not need to obtain the first related information from the second communication device for another time. Therefore, a waste of transmission resources caused by the second communication device repeatedly reporting the first related information can be reduced.

Certainly, after the first communication device obtains the first related information, when the first related information needs to be used, the first communication device may alternatively send the first related information to the third communication device, so that the third communication device may indicate, based on the first related information, the second communication device to perform AI positioning in a proper manner. The following provides an example for description.

In some embodiments of this application, after the foregoing step 101, the information reporting method provided in this embodiment of this application may further include the following step 206.

Step 206: The first communication device sends a second message to the third communication device.

In some embodiments of this application, when receiving a positioning-related task request (the positioning-related task request is used to request to obtain location information of the terminal) from another communication device, the first communication device may first obtain the first related information, and then determine, from a plurality of core network devices, the third communication device that performs a positioning operation, so that the first communication device may send the second message to the third communication device.

In this embodiment of this application, the second message includes the first related information.

In some embodiments of this application, the second message is used to request to obtain the location information of the terminal.

In some embodiments of this application, after the first communication device sends the second message to the third communication device, the third communication device may perform AI positioning via the second communication device based on the first related information, to determine the location information of the terminal.

It may be learned from that, when AI positioning is performed via the second communication device, the first communication device may alternatively indicate the first related information to the third communication device. In this way, the third communication device may determine, based on the first related information, a positioning manner of performing AI positioning via the second communication device, to determine a positioning manner in which the second communication device can perform AI positioning, instead of using a predetermined positioning manner. Therefore, this can reduce a probability that the second communication device cannot perform AI positioning in a positioning manner, so that a probability of a case in which the first communication device cannot determine the location information of the terminal can be reduced, and a probability of a case in which AI positioning fails to be performed can be reduced. In this way, a success rate of AI positioning can be improved.

In some embodiments of this application, after the foregoing step 206, the information reporting method provided in this embodiment of this application may further include the following step 207.

Step 207: The first communication device receives a third message from the third communication device.

In this embodiment of this application, the third message includes at least one of the following: first positioning result data; a data type corresponding to the first positioning result data; an AI positioning manner for performing AI positioning; or second indication information, where the second indication information is used to indicate that the first positioning result data is generated through AI positioning.

In some embodiments of this application, after performing AI positioning on the terminal via the second communication device, the third communication device may generate the third message based on data obtained through AI positioning, so that the first communication device may receive the third message from the third communication device.

It may be learned from this that the third communication device may further report, to the first communication device, the first positioning result data, the data type corresponding to the first positioning result data, the AI positioning manner for performing AI positioning, and the second indication information indicating that the first positioning result data is generated through AI positioning. In this way, the first communication device may clearly learn the location information of the terminal and related details of performing AI positioning. Therefore, in a subsequent step, the first communication device may accurately schedule, based on the location information of the terminal and the related details of performing AI positioning, a resource used by the terminal.

FIG. 4 is a schematic flowchart of the information reporting method according to an embodiment of this application. As shown in FIG. 4, the information reporting method provided in this embodiment of this application may include the following step 301.

Step 301: A second communication device sends a first message to a first communication device.

In some embodiments of this application, the second communication device may include at least one of the following: a terminal or an access network device. The first communication device may be a core network device, for example, an access and mobility management function (AMF) network element.

In some embodiments of this application, when the second communication device registers with the first communication device, the second communication device may send the first message to the first communication device. Alternatively, when the first communication device prepares to perform AI positioning via the second communication device, the second communication device may send the first message to the first communication device based on a request of the first communication device. Alternatively, among other interactions between the second communication device and the first communication device other than registration or AI positioning, the second communication device may send the first message to the first communication device.

In a case, when registering with the first communication device, the second communication device sends the first message to the first communication device. In this case, optionally, the first message is a registration message.

For example, when the second communication device is the terminal, the terminal may first send the first message to the access network device (for example, a registration message Registration Request), so that the access network device may determine a proper core network device as the first communication device based on a temporary subscriber identifier or a slice included in the Registration Request, and the access network device may forward the Registration Request to the first communication device. The first communication device may receive the Registration Request (that is, the first message).

In another case, when the first communication device prepares to trigger AI positioning performed via the second communication device, the second communication device sends the first message to the first communication device based on a request of the first communication device. Optionally, before step 301, the information reporting method provided in this embodiment of this application may include the following step 401, and the foregoing step 301 may be implemented by using the following step 301a.

Step 401: The second communication device receives a seventh message from the first communication device.

In this embodiment of this application, the seventh message is used to request the first related information.

In some embodiments of this application, the seventh message may be any one of the following: a long term evolution positioning protocol (LPP) message, a new radio positioning protocol (NRPP) message, and a non-access stratum (NAS) message.

Step 301a: The second communication device sends the first message to the first communication device based on the seventh message.

In some embodiments of this application, the second communication device may obtain the first related information based on the seventh message, and send the first message including the first related information to the first communication device.

It may be learned from that the second communication device reports the first related information to the first communication device only when the first communication device requests the first related information. Therefore, a case in which the first communication device has learned the first related information, but the second communication device repeatedly reports the first related information may be avoided, which can reduce a waste of transmission resources caused by repeatedly reporting the first related information.

In this embodiment of this application, the first message includes the first related information corresponding to the second communication device, and the first related information is used to perform AI positioning via the second communication device.

In some embodiments of this application, the first related information includes at least one of the following: capability information, where the capability information is used to indicate an AI positioning capability corresponding to the second communication device; or expected information, where the expected information is used to indicate a related manner expected by the second communication device for performing AI positioning.

The capability information may be understood as information about an AI positioning capability supported by the second communication device. The expected information may be understood as information that the second communication device expects to use AI positioning, for example, in which case AI positioning is used.

It may be learned from this that the first related information reported by the second communication device may include the capability information indicating the AI positioning capability that corresponds to the second communication device, and/or the AI positioning information expected by the second communication device. In this way, in a subsequent AI positioning process, another communication device may accurately determine whether AI positioning can be performed via the second communication device, and/or a manner suitable for performing AI positioning via the second communication device. Therefore, this can reduce a case of an AI positioning failure, and improve efficiency of interaction between the first communication device and the second communication device, and improve positioning accuracy by using an AI positioning method.

In some embodiments of this application, the capability information includes at least one of the following:
first indication information, where the first indication information is used to indicate that the second communication device supports AI positioning;
an AI positioning manner supported by the second communication device;
an input data type supported by the second communication device;
an output data type supported by the second communication device;
a data type that the second communication device supports for transmission; or
a data type of measurement data supported by the second communication device.

Optionally, when the second communication device supports AI positioning, the capability information may include the first indication information. When the second communication device does not support AI positioning, the capability information may not include the first indication information.

Optionally, the AI positioning manner includes at least one of the following:
a first manner, where the first manner is a manner in which a terminal generates positioning result data by using an AI positioning model;
a second manner, where the second manner is a manner in which the terminal generates positioning intermediate data by using the AI positioning model;
a third manner, where the third manner is a manner in which a third communication device generates positioning result data by using the AI positioning model;
a fourth manner, where the fourth manner is a manner in which an access network device generates positioning intermediate data by using an AI positioning model; or
a fifth manner, where the fifth manner is a manner in which a third communication device generates positioning result data by using the AI positioning model.

The positioning result data may be location information (Location) obtained by performing AI positioning. The positioning intermediate data may be intermediate feature data (Intermediate features) generated by performing AI positioning, and the intermediate feature data needs to be processed to obtain the location information (Location).

For example, in the first manner, the AI positioning model is set in the terminal. In this way, the access network device may send a positioning reference signal (PRS) to the terminal, so that the terminal may measure the PRS to obtain measurement data. The terminal may input the measurement data to the AI positioning model to obtain positioning intermediate data output by the AI positioning model. The AI positioning model may be an A-AIML model, that is, an Assist AIML model, is an auxiliary AIML model, or a model that can output intermediate data. The terminal may process the positioning intermediate data to generate the positioning result data. Alternatively, the terminal may input the measurement data to the AI positioning model to obtain positioning result data output by the AI positioning model. The AI positioning model may be a D-AIML model, that is, a Direct AIML model, or a model that can output the positioning result data. It should be noted that, in an actual application process, the first manner may also be referred to as another name, for example, case1.

For example, in the second manner, the AI positioning model is set in the terminal. In this way, the access network device may send a PRS to the terminal, so that the terminal may measure the PRS to obtain measurement data. The terminal may input the measurement data into the AI positioning model to obtain positioning intermediate data output by the AI positioning model. The AI positioning model may be an A-AIML model. The terminal may send the positioning intermediate data to another communication device (for example, the third communication device), so that the third communication device may process the positioning intermediate data to generate positioning result data. It should be noted that, in an actual application process, the second manner may also be referred to as another name, for example, case2a.

For example, in the third manner, the AI positioning model is set in the third communication device. In this way, the access network device may send a PRS to the terminal, so that the terminal may measure the PRS to obtain measurement data. The terminal may send the measurement data to the third communication device, so that the third communication device may input the measurement data to the AI positioning model to obtain positioning intermediate data output by the AI positioning model. The AI positioning model may be an A-AIML model. The third communication device may process the positioning intermediate data to generate positioning result data. Alternatively, the third communication device may input the measurement data to the AI positioning model to obtain positioning result data output by the AI positioning model. The AI positioning model may be a D-AIML model. It should be noted that, in an actual application process, the third manner may also be referred to as another name, for example, case2b.

For example, in the fourth manner, the AI positioning model is set in the access network device. In this way, the terminal may send a sounding reference signal (SRS) to the access network device, so that the access network device may measure the SRS to obtain measurement data. The access network device may input the measurement data into the AI positioning model to obtain positioning intermediate data output by the AI positioning model. The AI positioning model may be an A-AIML model. The access network device may process the positioning intermediate data to generate positioning result data. Alternatively, the access network device may input the measurement data to the AI positioning model to obtain positioning result data output by the AI positioning model. The AI positioning model may be a D-AIML model. It should be noted that, in an actual application process, the fourth manner may also be referred to as another name, for example, case3a.

For example, in the fifth manner, the AI positioning model is set in the third communication device. In this way, the terminal may send a SRS to the access network device, so that the access network device may measure the SRS to obtain measurement data. The access network device may send the measurement data to the third communication device, so that the third communication device may input the measurement data to the AI positioning model to obtain positioning intermediate data output by the AI positioning model. The AI positioning model may be an A-AIML model. The third communication device may process the positioning intermediate data to generate positioning result data. Alternatively, the third communication device may input the measurement data to the AI positioning model to obtain positioning result data output by the AI positioning model. The AI positioning model may be a D-AIML model. It should be noted that, in an actual application process, the fifth manner may also be referred to as another name, for example, case3b.

It may be learned from this that the AI positioning manner may include a plurality of different manners, and in subsequent steps, another communication device may select, based on a requirement, an AI positioning manner in which AI positioning is performed via the second communication device. Therefore, flexibility of performing AI positioning via the second communication device can be improved.

Optionally, when the second communication device includes the terminal, the AI positioning manner supported by the second communication device may include at least one of the following: the first manner, the second manner, or the third manner. When the second communication device includes the access network device, the AI positioning manner supported by the second communication device may include at least one of the following: the fourth manner or the fifth manner.

Optionally, a quantity of input data types supported by the second communication device may be at least one, and each input data type is a type of data that needs to be input in one AI positioning manner. The input data type supported by the second communication device may include at least one of the following: a channel impulse response (CIR), a power delay profile (PDP), time of arrival (TOA), a reference signal receiving power path (RSRPP), a path phase, or the like.

When the second communication device includes the terminal, the input data type supported by the second communication device may include at least one of the following: the CIR, the PDP, the TOA, or the like. When the second communication device includes the access network device, the input data type supported by the second communication device may include at least one of the following: the RSRPP, the TOA, the path phase, or the like.

Optionally, the output data type supported by the second communication device may include at least one of the following: positioning intermediate data, positioning result data, measurement data, or the like.

Optionally, the data type that the second communication device supports for transmission is used to indicate a data type that can be reported by the second communication device, that is, a data type that can be sent by the second communication device to a core network side (for example, the third communication device) in a positioning interaction process.

Optionally, the data type of the measurement data supported by the second communication device may include at least one of the following: a CIR, a PDP, a reference signal receiving power (RSRP), a RSRPP, or a reference signal time difference (RSTD).

It may be learned from this that this embodiment of this application specifies the content of the AI positioning capability that corresponds to the second communication device. In a subsequent step, another communication device may clearly learn, based on the content, the AI positioning capability that corresponds to the second communication device, to accurately determine, based on the AI positioning capability, whether to perform AI positioning via the second communication device, and/or a manner suitable for performing AI positioning via the second communication device is suitable. Therefore, this can reduce a case of an AI positioning failure.

In some embodiments of this application, the expected information includes at least one of the following:
an AI positioning manner expected by the second communication device;
an input data type expected by the second communication device;
an output data type expected by the second communication device;
a data type that the second communication device expects to send; or
a data type of measurement data expected by the second communication device.

It should be noted that for descriptions of the AI positioning manner, the input data type, the output data type, the sent data type, and the data type of measurement data, refer to descriptions in the foregoing embodiment. Details are not described herein again in this embodiment of this application.

It should be noted that the foregoing expected information may alternatively be understood as willingness information, and all is used to describe a condition and the like, expected by the second communication device, to be used in AI positioning.

It may be learned from this that this embodiment of this application specifies the content of a related manner that the second communication device expects for performing AI positioning. In this way, in a subsequent step, another device may clearly learn, based on the content, a related manner that the second communication device expects for performing AI positioning, to accurately determine, based on the related manner, a related manner expected by the second communication device. Therefore, the second communication device may perform AI positioning in the expected related manner.

According to an information reporting method provided in an embodiment of this application, a second communication device may send, to a first communication device, a first message including first related information corresponding to the second communication device. The first related information is used to perform AI positioning via the second communication device. The second communication device may send the first message to the first communication device, to report, to the first communication device, the first related information used to perform AI positioning via the second communication device. In this way, when AI positioning is performed via the second communication device, the first communication device may indicate another communication device to determine, based on the first related information, a positioning manner for performing AI positioning via the second communication device, to determine a positioning manner in which the second communication device may perform AI positioning instead of using a predetermined positioning manner. Therefore, this can reduce a probability that the second communication device cannot perform AI positioning in a positioning manner, so that probability of a case in which the first communication device cannot determine location information of a terminal can be reduced, and a probability of a case in which AI positioning fails to be performed can be reduced. In this way, a success rate of AI positioning can be improved.

In some embodiments of this application, after the foregoing step 301, the information reporting method provided in this embodiment of this application may further include the following step 402 and step 403.

Step 402: The second communication device receives an eighth message from the third communication device.

In this embodiment of this application, the eighth message includes second related information for performing AI positioning via the second communication device.

In some embodiments of this application, the eighth message may be a positioning interaction request message.

In some embodiments of this application, the third communication device may send the eighth message to the second communication device through an LPP message, an NRPP message, or a NAS message, or the third communication device may send the eighth message to the second communication device via the first communication device.

In this embodiment of this application, the eighth message includes the second related information for performing AI positioning via the second communication device, and the eighth message is used to request to perform AI positioning based on the second related information.

The second related information is determined by the third communication device based on the first related information.

In some embodiments of this application, the second related information includes at least one of the following:
third indication information, where the third indication information is used to indicate to perform AI positioning;
an AI positioning manner;
a data type of measurement data to be reported;
a data type of positioning intermediate data to be reported; or
a data type of positioning result data to be reported.

It may be learned from this that this embodiment of this application specifies the content of the second related information. In a subsequent step, the second communication device may accurately determine, based on the content, whether to perform AI positioning and/or a related manner for performing AI positioning. Therefore, this can reduce a probability of a case in which AI positioning performed via the second communication device fails.

Step 403: The second communication device performs AI positioning based on the second related information.

In some embodiments of this application, the second communication device may perform AI positioning in the AI positioning manner in the second related information, generate at least one of measurement data of a data type that needs to be reported, positioning intermediate data of a data type that needs to be reported, or positioning result data of a data type that needs to be reported in the second related information, and send the generated data to the third communication device, to perform AI positioning on the terminal.

It may be learned from this that the second communication device receives the eighth message sent by the third communication device, to obtain the second related information for performing AI positioning. In this way, the second communication device may perform AI positioning based on the second related information in a positioning manner that may be used by the second communication device, instead of performing AI positioning in a predetermined positioning manner. Therefore, this can reduce a probability of a case in which the second communication device cannot perform AI positioning.

Certainly, after performing AI positioning on the terminal, the second communication device may report related data obtained by performing AI positioning, so that the first communication device can learn the location information of the terminal. The following provides an example for description.

In some embodiments of this application, after the foregoing step 403, the information reporting method provided in this embodiment of this application may further include the following step 404.

Step 404: The second communication device sends a ninth message to the third communication device.

The ninth message includes at least one of the following: first positioning data, where the first positioning data includes at least one of the following: positioning result data, positioning intermediate data, or measurement data; a data type corresponding to the first positioning data; an AI positioning manner for performing AI positioning; or fourth indication information, where the fourth indication information is used to indicate that the first positioning data is generated through AI positioning.

In some embodiments of this application, when the second communication device performs AI positioning on the terminal by using different AI positioning manners, the first positioning data is also different. For example, when the second communication device performs AI positioning on the terminal in the first manner, the first positioning data may be the positioning result data or the positioning intermediate data.

It may be learned from this that after performing AI positioning, the second communication device may further send the ninth message to the third communication device, to indicate, to the third communication device, the first positioning data, the data type corresponding to the first positioning data, the positioning manner for performing AI positioning, and the fourth indication information indicating that the first positioning data is generated through AI positioning. In this way, the third communication device may accurately determine the location information of the terminal based on the ninth message. Therefore, the third communication device may report accurate location information of the terminal to the first communication device, so that the first communication device can learn the accurate location information of the terminal.

FIG. 5 is a schematic flowchart of the information reporting method according to an embodiment of this application. As shown in FIG. 5, the information reporting method provided in this embodiment of this application may include the following step 501 and step 502.

Step 501: A third communication device receives a second message from a first communication device.

In some embodiments of this application, the third communication device may be a core network device, for example, a location management function (LMF) network element, and the first communication device may be a core network device, for example, an AMF network element.

In some embodiments of this application, before the foregoing step 501, the information reporting method provided in this embodiment of this application may further include the following step 601.

Step 601: The third communication device sends a seventh message to the second communication device via the first communication device.

In this embodiment of this application, the seventh message is used to request the first related information.

In some embodiments of this application, the seventh message may be any one of the following: a long term evolution positioning protocol (LPP) message, a new radio positioning protocol (NRPP) message, and a non-access stratum (NAS) message.

In some embodiments of this application, when receiving a positioning request of a first device, the first communication device may determine whether the first related information is stored in the first communication device or another communication device (for example, a fourth communication device in the following embodiments). In this way, when determining that the first related information is not stored in the first communication device or the another communication device, the first communication device may send a location obtaining request to the third communication device, to request to obtain location information of the terminal. Then, the third communication device may send the seventh message to the second communication device via the first communication device based on the location obtaining request.

The first device may be a terminal or a mobile location center gateway (Gateway Mobile Location Center, GMLC) network element.

It may be learned from this that the third communication device may request the first related information from the second communication device via the first communication device based on a requirement, so that the second communication device may report the first related information based on the request. Therefore, a case in which the third communication device or the first communication device has learned the first related information, but the second communication device repeatedly reports the first related information may be avoided, which can reduce a waste of transmission resources caused by repeatedly reporting the first related information.

In this embodiment of this application, the second message includes the first related information corresponding to the second communication device.

It should be noted that the first related information may be applicable to determining a positioning manner related to the second communication device, for example, AI positioning and an AI positioning manner.

In some embodiments of this application, the first related information includes at least one of the following:
capability information, where the capability information is used to indicate an AI positioning capability corresponding to the second communication device; or
expected information, where the expected information is used to indicate a related manner expected by the second communication device for performing AI positioning.

The capability information may be understood as information about an AI positioning capability supported by the second communication device. The expected information may be understood as information that the second communication device expects to use AI positioning, for example, in which case AI positioning is used.

It may be learned from this that the first related information reported by the second communication device may include the capability information indicating the AI positioning capability that corresponds to the second communication device and/or AI positioning information expected by the second communication device, so that in a subsequent AI positioning process, another communication device may accurately determine whether AI positioning can be performed via the second communication device, and/or a manner suitable for performing AI positioning via the second communication device. Therefore, this can reduce a case of an AI positioning failure, and improve efficiency of interaction between the first communication device and the second communication device, and improve positioning accuracy by using an AI positioning method.

In some embodiments of this application, the capability information includes at least one of the following:
first indication information, where the first indication information is used to indicate that the second communication device supports AI positioning;
an AI positioning manner supported by the second communication device;
an input data type supported by the second communication device;
an output data type supported by the second communication device;
a data type that the second communication device supports for transmission; or
a data type of measurement data supported by the second communication device.

Optionally, when the second communication device supports AI positioning, the capability information may include the first indication information. When the second communication device does not support AI positioning, the capability information may not include the first indication information.

Optionally, the AI positioning manner includes at least one of the following:
a first manner, where the first manner is a manner in which a terminal generates positioning result data by using an AI positioning model;
a second manner, where the second manner is a manner in which the terminal generates positioning intermediate data by using the AI positioning model;
a third manner, where the third manner is a manner in which a third communication device generates positioning result data by using the AI positioning model;
a fourth manner, where the fourth manner is a manner in which an access network device generates positioning intermediate data by using an AI positioning model; or
a fifth manner, where the fifth manner is a manner in which a third communication device generates positioning result data by using the AI positioning model.

The positioning result data may be location information (Location) obtained by performing AI positioning. The positioning intermediate data may be intermediate feature data (Intermediate features) generated by performing AI positioning, and the intermediate feature data needs to be processed to obtain the location information (Location).

For example, in the first manner, the AI positioning model is set in the terminal. In this way, the access network device may send a positioning reference signal (PRS) to the terminal, so that the terminal may measure the PRS to obtain measurement data. The terminal may input the measurement data to the AI positioning model to obtain positioning intermediate data output by the AI positioning model. The AI positioning model may be an A-AIML model, that is, an Assist AIML model, is an auxiliary AIML model, or a model that can output intermediate data. The terminal may process the positioning intermediate data to generate the positioning result data. Alternatively, the terminal may input the measurement data to the AI positioning model to obtain positioning result data output by the AI positioning model. The AI positioning model may be a D-AIML model, that is, a Direct AIML model, or a model that can output the positioning result data. It should be noted that, in an actual application process, the first manner may also be referred to as another name, for example, case1.

For example, in the second manner, the AI positioning model is set in the terminal. In this way, the access network device may send a PRS to the terminal, so that the terminal may measure the PRS to obtain measurement data. The terminal may input the measurement data into the AI positioning model to obtain positioning intermediate data output by the AI positioning model. The AI positioning model may be an A-AIML model. The terminal may send the positioning intermediate data to another communication device (for example, the third communication device), so that the third communication device may process the positioning intermediate data to generate positioning result data. It should be noted that, in an actual application process, the second manner may also be referred to as another name, for example, case2a.

For example, in the third manner, the AI positioning model is set in the third communication device. In this way, the access network device may send a PRS to the terminal, so that the terminal may measure the PRS to obtain measurement data. The terminal may send the measurement data to the third communication device, so that the third communication device may input the measurement data to the AI positioning model to obtain positioning intermediate data output by the AI positioning model. The AI positioning model may be an A-AIML model. The third communication device may process the positioning intermediate data to generate positioning result data. Alternatively, the third communication device may input the measurement data to the AI positioning model to obtain positioning result data output by the AI positioning model. The AI positioning model may be a D-AIML model. It should be noted that, in an actual application process, the third manner may also be referred to as another name, for example, case2b.

For example, in the fourth manner, the AI positioning model is set in the access network device. In this way, the terminal may send a sounding reference signal (SRS) to the access network device, so that the access network device may measure the SRS to obtain measurement data. The access network device may input the measurement data into the AI positioning model to obtain positioning intermediate data output by the AI positioning model. The AI positioning model may be an A-AIML model. The access network device may process the positioning intermediate data to generate positioning result data. Alternatively, the access network device may input the measurement data to the AI positioning model to obtain positioning result data output by the AI positioning model. The AI positioning model may be a D-AIML model. It should be noted that, in an actual application process, the fourth manner may also be referred to as another name, for example, case3a.

For example, in the fifth manner, the AI positioning model is set in the third communication device. In this way, the terminal may send a SRS to the access network device, so that the access network device may measure the SRS to obtain measurement data. The access network device may send the measurement data to the third communication device, so that the third communication device may input the measurement data to the AI positioning model to obtain positioning intermediate data output by the AI positioning model. The AI positioning model may be an A-AIML model. The third communication device may process the positioning intermediate data to generate positioning result data. Alternatively, the third communication device may input the measurement data to the AI positioning model to obtain positioning result data output by the AI positioning model. The AI positioning model may be a D-AIML model. It should be noted that, in an actual application process, the fifth manner may also be referred to as another name, for example, case3b.

It may be learned from this that the AI positioning manner may include a plurality of different manners, and in subsequent steps, another communication device may select, based on a requirement, an AI positioning manner in which AI positioning is performed via the second communication device. Therefore, flexibility of performing AI positioning via the second communication device can be improved.

Optionally, when the second communication device includes the terminal, the AI positioning manner supported by the second communication device may include at least one of the following: the first manner, the second manner, or the third manner. When the second communication device includes the access network device, the AI positioning manner supported by the second communication device may include at least one of the following: the fourth manner or the fifth manner.

Optionally, a quantity of input data types supported by the second communication device may be at least one, and each input data type is a type of data that needs to be input in one AI positioning manner. The input data type supported by the second communication device may include at least one of the following: a channel impulse response (CIR), a power delay profile (PDP), time of arrival (TOA), a reference signal receiving power path (RSRPP), a path phase, or the like.

When the second communication device includes the terminal, the input data type supported by the second communication device may include at least one of the following: the CIR, the PDP, the TOA, or the like. When the second communication device includes the access network device, the input data type supported by the second communication device may include at least one of the following: the RSRPP, the TOA, the path phase, or the like.

Optionally, the output data type supported by the second communication device may include at least one of the following: positioning intermediate data, positioning result data, measurement data, or the like.

Optionally, the data type that the second communication device supports for transmission is used to indicate a data type that can be reported by the second communication device, that is, a data type that can be sent by the second communication device to a core network side (for example, the third communication device) in a positioning interaction process.

Optionally, the data type of the measurement data supported by the second communication device may include at least one of the following: a CIR, a PDP, a reference signal receiving power (RSRP), a RSRPP, or a reference signal time difference (RSTD).

It may be learned from this that this embodiment of this application specifies the content of the AI positioning capability that corresponds to the second communication device. In a subsequent step, another communication device may clearly learn, based on the content, the AI positioning capability that corresponds to the second communication device, to accurately determine, based on the AI positioning capability, whether to perform AI positioning via the second communication device, and/or a manner suitable for performing AI positioning via the second communication device is suitable. Therefore, this can reduce a case of an AI positioning failure.

In some embodiments of this application, the expected information includes at least one of the following:
an AI positioning manner expected by the second communication device;
an input data type expected by the second communication device;
an output data type expected by the second communication device;
a data type that the second communication device expects to send; or
a data type of measurement data expected by the second communication device.

It should be noted that for descriptions of the AI positioning manner, the input data type, the output data type, the sent data type, and the data type of measurement data, refer to descriptions in the foregoing embodiment. Details are not described herein again in this embodiment of this application.

It should be noted that the foregoing expected information may alternatively be understood as willingness information, and all is used to describe a condition and the like, expected by the second communication device, to be used in AI positioning.

It may be learned from this that this embodiment of this application specifies the content of a related manner that the second communication device expects for performing AI positioning. In this way, in a subsequent step, another device may clearly learn, based on the content, a related manner that the second communication device expects for performing AI positioning, to accurately determine, based on the related manner, a related manner expected by the second communication device. Therefore, the second communication device may perform AI positioning in the expected related manner.

Step 502: The third communication device performs AI positioning via the second communication device based on the first related information.

In some embodiments of this application, the third communication device may first determine, based on the first related information, related information (for example, second related information in the following embodiments) for performing AI positioning, and then perform AI positioning via the second communication device based on determined related information.

According to an information reporting method provided in an embodiment of this application, the third communication device receives the second message, including the first related information corresponding to the second communication device, from the first communication device, so that the third communication device may perform AI positioning via the second communication device based on the first related information. The first related information is used to perform AI positioning via the second communication device. The third communication device may obtain the first related information corresponding to the second communication device from the first communication device. In this way, the third communication device may indicate, based on the first related information corresponding to the second communication device, the second communication device to perform AI positioning via the second communication device in a positioning manner in which the second communication device can perform AI positioning instead of indicating the second communication device to perform AI positioning via the second communication device in a predetermined positioning manner. Therefore, this can reduce a probability that the second communication device cannot perform AI positioning in a positioning manner, so that probability of a case in which the first communication device cannot determine location information of a terminal can be reduced, and a probability of a case in which AI positioning fails to be performed can be reduced. In this way, a success rate of AI positioning can be improved.

In some embodiments of this application, after the foregoing step 501, the information reporting method provided in this embodiment of this application may further include the following step 602.

Step 602: The third communication device determines, based on the first related information, second related information for performing AI positioning via the second communication device.

In some embodiments of this application, the second related information includes at least one of the following:
third indication information, where the third indication information is used to indicate to perform AI positioning;
an AI positioning manner;
a data type of measurement data to be reported;
a data type of positioning intermediate data to be reported; or
a data type of positioning result data to be reported.

Optionally, when the third communication device determines that AI positioning needs to be performed via the second communication device, the second related information may include the third indication information. When the third communication device determines not to perform AI positioning via the second communication device, the second related information may not include the third indication information.

Optionally, when the second communication device includes the terminal, the AI positioning manner may include at least one of the following: the first manner, the second manner, or the third manner. When the second communication device includes the access network device, the AI positioning manner may include at least one of the following: the fourth manner or the fifth manner.

It should be noted that the third communication device may determine the second related information based on the capability information and the willingness information in the first related information. For example, the third communication device determines the AI positioning manner in the second related information based on the AI positioning manner supported by the second communication device in the first related information and/or the AI positioning manner expected by the second communication device in the willingness information. Other methods are similar. Details are not described again.

It may be learned from this that this embodiment of this application specifies the content of the second related information. In a subsequent step, the second communication device may accurately determine, based on the content, whether to perform AI positioning and/or a related manner for performing AI positioning. Therefore, this can reduce a probability of a case in which AI positioning performed via the second communication device fails.

In some embodiments of this application, when the first related information includes the capability information and/or the expected information, the third communication device may first determine, based on the capability information, at least one of the positioning manner supported by the second communication device, the input data type supported by the second communication device, the output data type supported by the second communication device, the data type that the second communication device supports for transmission, or the data type of measurement data supported by the second communication device; and then determine, based on the expected information, the AI positioning manner expected by the second communication device, the input data type expected by the second communication device, the output data type expected by the second communication device, the data type that the second communication device expects to send, and the data type of measurement data expected by the second communication device. In this way, the third communication device may determine the second related information based on an AI positioning manner supported and expected by the second communication device, an input data type supported and expected by the second communication device, an output data type supported and expected by the second communication device, a data type that the second communication device supports and expects for transmission, and a data type of measurement data supported and expected by the second communication device.

It may be learned from this that the third communication device may determine, based on the first related information, the second related information for performing AI positioning via the second communication device. The second related information is related information of a positioning manner that can be used by the second communication device. In this way, in a subsequent step, the second communication device may perform AI positioning in the positioning manner based on the second related information, instead of performing AI positioning in a predetermined positioning manner. Therefore, this can reduce a probability that the second communication device cannot perform AI positioning in a positioning manner, so that a probability of a case in which the first communication device cannot determine the location information of the terminal can be reduced.

In some embodiments of this application, after the foregoing step 501, the information reporting method provided in this embodiment of this application may further include the following step 603.

Step 603: The third communication device sends an eighth message to the second communication device.

In some embodiments of this application, the eighth message may be a positioning interaction request message.

In some embodiments of this application, the third communication device may send the eighth message to the second communication device through an LPP message, an NRPP message, or a NAS message, or the third communication device may send the eighth message to the second communication device via the first communication device.

In this embodiment of this application, the eighth message includes the second related information for performing AI positioning via the second communication device, and the eighth message is used to request to perform AI positioning based on the second related information.

It may be learned from this that the third communication device may send the eighth message to the second communication device, to indicate, to the second communication device, the second related information for the second communication device to perform AI positioning. In this way, the second communication device may perform AI positioning based on the second related information in a positioning manner that may be used by the second communication device, instead of performing AI positioning in a predetermined positioning manner. Therefore, this can reduce a probability of a case in which the second communication device cannot perform AI positioning.

In some embodiments of this application, after the foregoing step 603, the information reporting method provided in this embodiment of this application may further include the following step 604.

Step 604: The third communication device receives a ninth message from the second communication device.

The ninth message includes at least one of the following:
first positioning data, where the first positioning data includes at least one of the following: positioning result data, positioning intermediate data, or measurement data;
a data type corresponding to the first positioning data;
an AI positioning manner for performing AI positioning; or
fourth indication information, where the fourth indication information is used to indicate that the first positioning data is generated through AI positioning.

In some embodiments of this application, when the second communication device performs AI positioning on the terminal by using different AI positioning manners, the first positioning data is also different. For example, when the second communication device performs AI positioning on the terminal in the first manner, the first positioning data may be the positioning result data or the positioning intermediate data.

It may be learned from this that after performing AI positioning, the second communication device may send the ninth message to the third communication device, to indicate, to the third communication device, the first positioning data, the data type corresponding to the first positioning data, the positioning manner for performing AI positioning, and the fourth indication information indicating that the first positioning data is generated through AI positioning. In this way, the third communication device may accurately determine the location information of the terminal based on the ninth message. Therefore, the third communication device may report accurate location information of the terminal to the first communication device, so that the first communication device can learn the accurate location information of the terminal.

In some embodiments of this application, after the foregoing step 604, the information reporting method provided in this embodiment of this application may further include the following step 605.

Step 605: The third communication device sends a third message to the first communication device.

In this embodiment of this application, the third message includes at least one of the following:
first positioning result data;
a data type corresponding to the first positioning result data;
an AI positioning manner for performing AI positioning; or
second indication information, where the second indication information is used to indicate that the first positioning result data is generated through AI positioning.

In some embodiments of this application, when receiving the ninth message, the third communication device may determine the first positioning result data based on the first positioning data, determine the data type corresponding to the first positioning result data, and determine the AI positioning manner for performing AI positioning. In this way, the third communication device may generate the third message, and send the third message to the first communication device.

Optionally, when the first positioning data is the positioning result data, the third communication device may directly determine the positioning result data as the first positioning result data. When the first positioning data is the positioning intermediate data, the third communication device may process the positioning intermediate data, to obtain the first positioning result data. When the first positioning data is measurement data, the third communication device may input the measurement data to the AI positioning model, to obtain first positioning result data output by the AI positioning model, or obtain positioning intermediate data output by the AI positioning model, so that the third communication device may generate the first positioning result data based on the positioning intermediate data.

Optionally, the third communication device may determine, based on the AI positioning manner for performing AI positioning in the ninth message, the AI positioning manner for performing AI positioning.

It may be learned from this that the third communication device may report, to the first communication device, the first positioning result data, the data type corresponding to the first positioning result data, the AI positioning manner for performing AI positioning, and the second indication information indicating that the first positioning result data is generated through AI positioning. In this way, the first communication device may clearly learn the location information of the terminal and related details of performing AI positioning. Therefore, in a subsequent step, the first communication device may accurately schedule, based on the location information of the terminal and the related details of performing AI positioning, a resource used by the terminal.

The following uses five different examples to describe an interaction process of an information reporting method provided in embodiments of this application when a second communication device includes different devices.

Example 1: The second communication device is a terminal, and the terminal actively reports first related information.

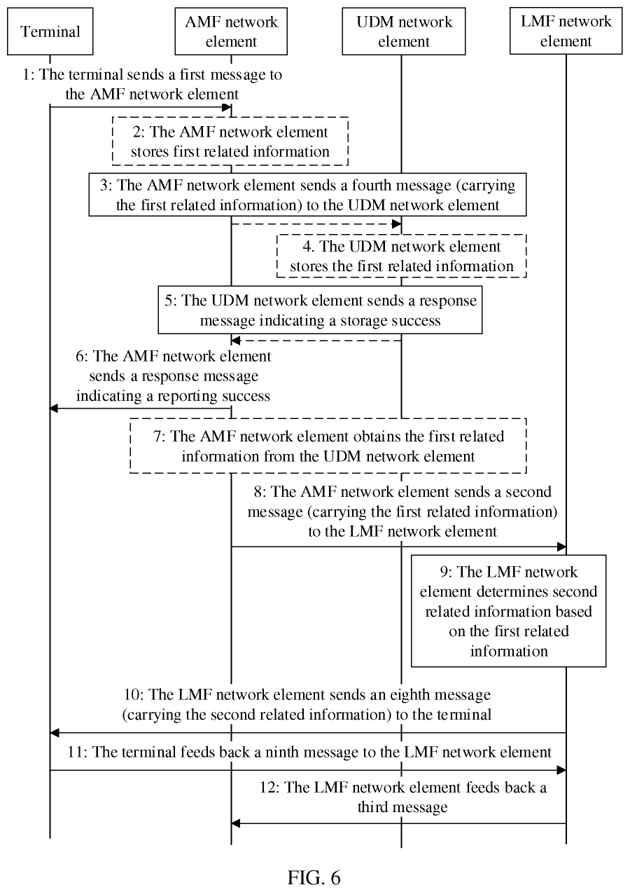

As shown in FIG. 6, in Example 1, the information reporting method may include the following steps.
1: The terminal sends a first message (for example, a registration message) to a first communication device (for example, an AMF network element), where the registration message includes the first related information corresponding to the terminal.
2: In one case, when receiving the registration message, the AMF network element may store the first related information in the AMF network element.
3: In another case, when receiving the registration message, the AMF network element may send a fourth message to a fourth communication device (for example, a UDM network element), where the fourth message includes the first related information.
4: After the foregoing step 3, the UDM network element may store the first related information.
5: The UDM network element may send a response message to the AMF network element, where the response message is used to indicate that the first related information has been stored.
6: The AMF network element may send a response message to the terminal, where the response message is used to indicate that the first related information is stored or that the terminal is successfully registered.
7: After receiving a positioning-related task request of the terminal, the AMF network element may interact with the UDM network element, to obtain the first related information from the UDM network element.
8: The AMF network element may send a second message to a third communication device (for example, an LMF network element), where the second message includes the first related information, and the second message is used to request to obtain location information of the terminal.
9: The LMF network element may determine, based on the first related information, second related information for performing AI positioning on the terminal.
10: The LMF network element may send an eighth message (for example, a positioning interaction request message) to the terminal, where the positioning interaction request message includes the second related information.
11: The terminal may perform AI positioning on the terminal based on the second related information, and feed back a ninth message to the LMF network element.
12: The LMF network element may send a third message to the AMF network element based on the ninth message, so that the AMF network element may determine the location information of the terminal based on information in the third message, to complete an entire AI positioning procedure.

Example 2: The second communication device is a terminal, and the terminal requests to report first related information.

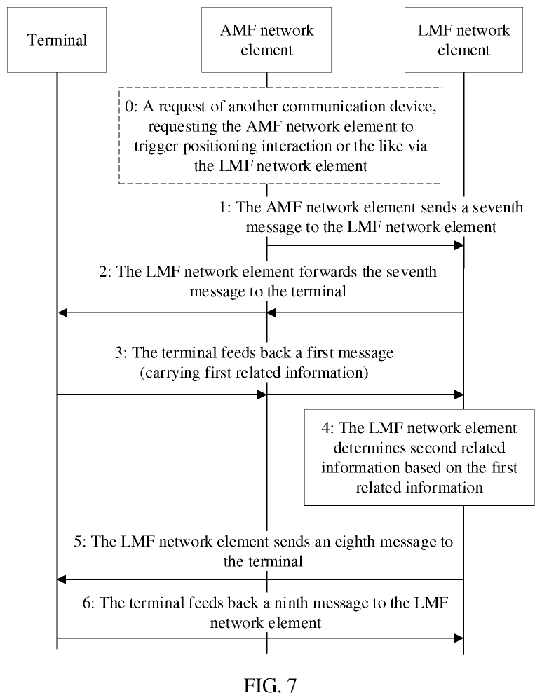

As shown in FIG. 7, in Example 2, the information reporting method may include the following steps.
0: A first communication device (for example, an AMF network element) receives a request of another device (for example, the terminal or a GMLC), prepares to trigger a positioning procedure, and prepares to request a third communication device (for example, an LMF network element to perform positioning interaction).
1: The AMF network element sends a seventh message (for example, a location obtaining request message) to an LMF network element, to request to obtain location information of the terminal. Optionally, when determining that the AMF network element or the UDM network element does not store the first related information corresponding to the terminal, the AMF network element may send the location obtaining request message to the LMF network element.
2: The LMF network element may forward the seventh message to the terminal (via the AMF network element).
3: The terminal may send a first message to the AMF network element, where the first message includes the first related information.
Steps 4 to 6 are similar to steps 9 to 11 in Example 1.
7: The LMF network element may send a third message to the AMF network element based on the ninth message, so that the AMF network element may determine the location information of the terminal based on information in the third message, to complete an entire AI positioning procedure.

Example 3: The second communication device is an access network device, and the access network device actively reports first related information.

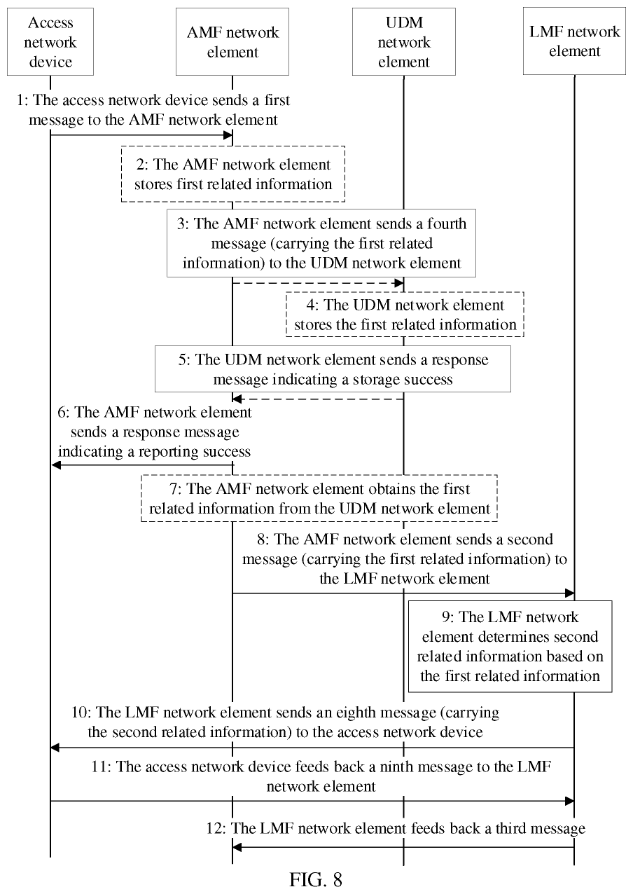

As shown in FIG. 8, in Example 3, the information reporting method may include the following steps.
Steps 1 to 9 are similar to those in Example 1, and a difference is that the second communication device is the access network device, and the content of the sent first related information is different from that in Example 1.
Steps 10 to 12 are similar to steps 10 to 12 in Example 1.

Example 4: The second communication device is an access network device, and the access network device requests to report first related information.

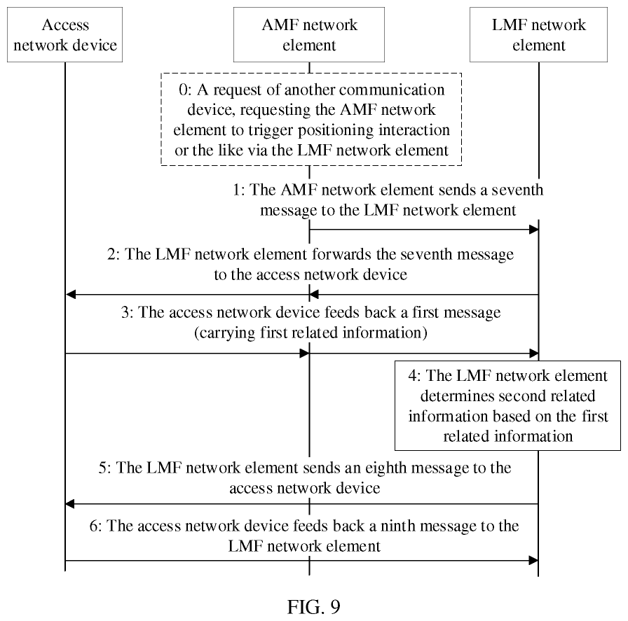

As shown in FIG. 9, in Example 4, the information reporting method may include the following steps.
Steps 1 to 3 are similar to those in Example 2, and a difference is that the second communication device is the access network device, and the content of the sent first related information is different from that in Example 2.
Steps 4 to 6 are similar to steps 9 to 11 in Example 3.
7: The LMF network element may send a third message to the AMF network element based on the ninth message, so that the AMF network element may determine the location information of the terminal based on information in the third message, to complete an entire AI positioning procedure.

Example 5: The second communication device is an access network device and a terminal, and the terminal and the access network device actively report first related information.

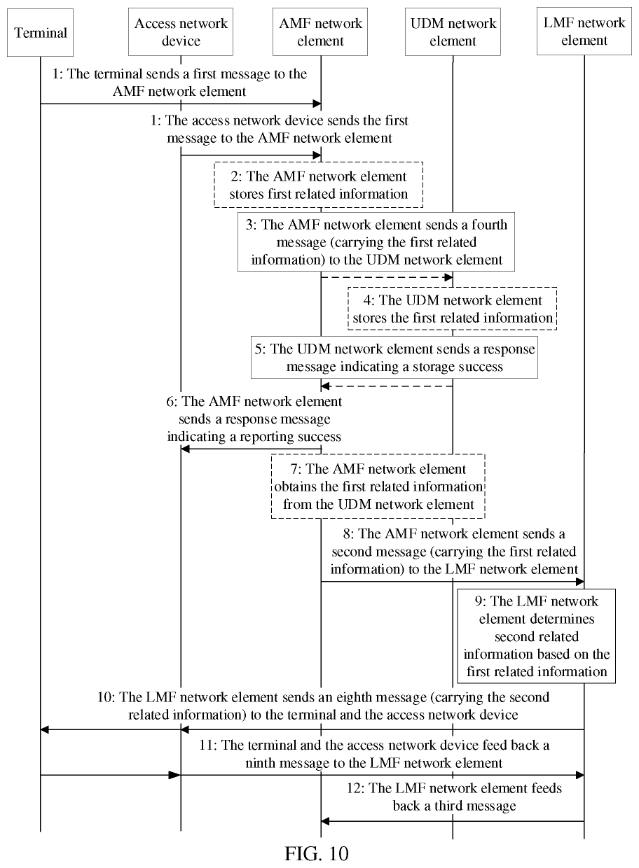

As shown in FIG. 10, in Example 5, the information reporting method may include the following steps.
Steps 1 to 11 are similar to those in Example 1 and Example 3. A difference is that, in Example 5, the LMF network element may determine, based on both first related information corresponding to the terminal and first related information corresponding to the access network device, the second related information for performing AI positioning.

Each of the foregoing method embodiments or various possible implementations in each method embodiment may be performed independently, or may be performed in any combination of two or more thereof, which may be determined based on an actual use requirement. This is not limited in embodiments of this application.

The information reporting method provided in embodiments of this application may be performed by an information reporting apparatus. In embodiments of this application, an example in which the information reporting apparatus performs the information reporting method is used to describe the information reporting apparatus provided in embodiments of this application.

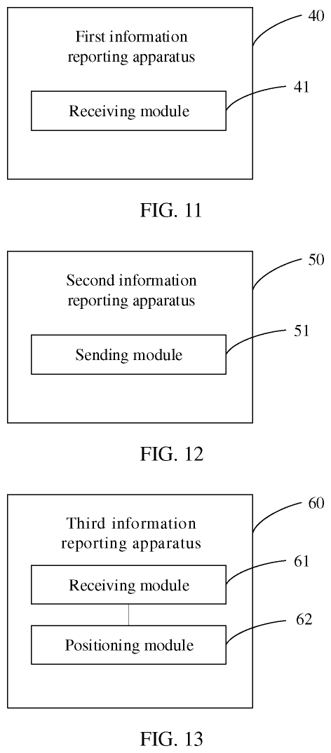

FIG. 11 is a schematic diagram of a possible structure of an information reporting apparatus according to an embodiment of this application. The information reporting apparatus is a first information reporting apparatus. As shown in FIG. 11, the first information reporting apparatus 40 provided in this embodiment of this application may include: a receiving module 41, configured to receive a first message from a second information reporting apparatus. The first message includes first related information corresponding to the second information reporting apparatus. The first related information is used to perform AI positioning via the second information reporting apparatus.

This embodiment of this application provides an information reporting apparatus, and the information reporting apparatus is the first information reporting apparatus. The second information reporting apparatus may send the first message to the first information reporting apparatus, to report, to the first information reporting apparatus, the first related information used to perform AI positioning via the second information reporting apparatus. In this way, when AI positioning is performed via the second information reporting apparatus, the first information reporting apparatus may determine, based on the first related information, a positioning manner for performing AI positioning via the second information reporting apparatus, to determine a positioning manner in which the second information reporting apparatus may perform AI positioning instead of using a predetermined positioning manner. Therefore, this can reduce a probability that the second information reporting apparatus cannot perform AI positioning in a positioning manner, so that probability of a case in which the first information reporting apparatus cannot determine location information of a terminal can be reduced, and a probability of a case in which AI positioning fails to be performed can be reduced. In this way, a success rate of AI positioning can be improved.

In a possible implementation, the first related information includes at least one of the following: capability information, where the capability information is used to indicate an AI positioning capability corresponding to the second information reporting apparatus; or expected information, where the expected information is used to indicate a related manner expected by the second information reporting apparatus for performing AI positioning.

In a possible implementation, the capability information includes at least one of the following: first indication information, where the first indication information is used to indicate that the second information reporting apparatus supports AI positioning; an AI positioning manner supported by the second information reporting apparatus; an input data type supported by the second information reporting apparatus; an output data type supported by the second information reporting apparatus; a data type that the second information reporting apparatus supports for transmission; or a data type of measurement data supported by the second information reporting apparatus.

In a possible implementation, the expected information includes at least one of the following: an AI positioning manner expected by the second information reporting apparatus; an input data type expected by the second information reporting apparatus; an output data type expected by the second information reporting apparatus; a data type that the second information reporting apparatus expects to send; or a data type of measurement data expected by the second information reporting apparatus.

In a possible implementation, the AI positioning manner includes at least one of the following: a first manner, where the first manner is a manner in which a terminal generates positioning result data by using an AI positioning model; a second manner, where the second manner is a manner in which the terminal generates positioning intermediate data by using the AI positioning model; a third manner, where the third manner is a manner in which a third information reporting apparatus generates positioning result data by using the AI positioning model; a fourth manner, where the fourth manner is a manner in which an access network device generates positioning intermediate data by using an AI positioning model; or a fifth manner, where the fifth manner is a manner in which a third information reporting apparatus generates positioning result data by using the AI positioning model.

In a possible implementation, the first information reporting apparatus 40 provided in this embodiment of this application may further include: a sending module, configured to: after the receiving module 41 receives the first message from the second information reporting apparatus, send a second message to the third information reporting apparatus. The second message includes the first related information.

In a possible implementation, the receiving module 41 is further configured to: after the sending module sends the second message to the third information reporting apparatus, receive a third message from the third information reporting apparatus. The third message includes at least one of the following: first positioning result data; a data type corresponding to the first positioning result data; an AI positioning manner for performing AI positioning; or second indication information, where the second indication information is used to indicate that the first positioning result data is generated through AI positioning.

In a possible implementation, the first information reporting apparatus 40 provided in this embodiment of this application may further include: a storage module, configured to: after the receiving module 41 receives the first message from the second information reporting apparatus, store the first related information. Alternatively, the sending module is configured to: after the receiving module 41 receives the first message from the second information reporting apparatus, send a fourth message to a fourth information reporting apparatus. The fourth message includes the first related information.

In a possible implementation, the sending module is further configured to: after the sending module sends the fourth message to the fourth information reporting apparatus, send a fifth message to the fourth information reporting apparatus. The fifth message is used to request the first related information. The receiving module 41 is further configured to receive a sixth message from the fourth information reporting apparatus. The sixth message includes the first related information.

In a possible implementation, the first message is a registration message.

In a possible implementation, the first information reporting apparatus 40 provided in this embodiment of this application may further include: a sending module, configured to: before the receiving module 41 receives the first message from the second information reporting apparatus, send a seventh message to the second information reporting apparatus. The seventh message is used to request the first related information.

The first information reporting apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not limited in embodiments of this application.

The first information reporting apparatus provided in this embodiment of this application can implement each process implemented in the method embodiment of FIG. 3, and achieve same technical effect. To avoid repetition, details are not described herein again.

FIG. 12 is a schematic diagram of a possible structure of an information reporting apparatus according to an embodiment of this application. The information reporting apparatus is a second information reporting apparatus. As shown in FIG. 12, the second information reporting apparatus 50 provided in this embodiment of this application may include: a sending module 51, configured to send a first message to a first information reporting apparatus. The first message includes first related information corresponding to the second information reporting apparatus 50. The first related information is used to perform AI positioning via the second information reporting apparatus 50.

This embodiment of this application provides an information reporting apparatus, and the information reporting apparatus is the second information reporting apparatus. The second information reporting apparatus may send the first message to the first information reporting apparatus, to report, to the first information reporting apparatus, the first related information used to perform AI positioning via the second information reporting apparatus. In this way, when AI positioning is performed via the second information reporting apparatus, the first information reporting apparatus may determine, based on the first related information, a positioning manner for performing AI positioning via the second information reporting apparatus, to determine a positioning manner in which the second information reporting apparatus may perform AI positioning instead of using a predetermined positioning manner. Therefore, this can reduce a probability that the second information reporting apparatus cannot perform AI positioning in a positioning manner, so that probability of a case in which the first information reporting apparatus cannot determine location information of a terminal can be reduced, and a probability of a case in which AI positioning fails to be performed can be reduced. In this way, a success rate of AI positioning can be improved.

In a possible implementation, the first related information includes at least one of the following: capability information, where the capability information is used to indicate an AI positioning capability corresponding to the second information reporting apparatus 50; or expected information, where the expected information is used to indicate a related manner expected by the second information reporting apparatus 50 for performing AI positioning.

In a possible implementation, the capability information includes at least one of the following: first indication information, where the first indication information is used to indicate that the second information reporting apparatus 50 supports AI positioning; an AI positioning manner supported by the second information reporting apparatus 50; an input data type supported by the second information reporting apparatus 50; an output data type supported by the second information reporting apparatus 50; a data type that the second information reporting apparatus 50 supports for transmission; or a data type of measurement data supported by the second information reporting apparatus 50.

In a possible implementation, the expected information includes at least one of the following: an AI positioning manner expected by the second information reporting apparatus 50; an input data type expected by the second information reporting apparatus 50; an output data type expected by the second information reporting apparatus 50; a data type that the second information reporting apparatus 50 expects to send; or a data type of measurement data expected by the second information reporting apparatus 50.

In a possible implementation, the AI positioning manner includes at least one of the following: a first manner, where the first manner is a manner in which a terminal generates positioning result data by using an AI positioning model; a second manner, where the second manner is a manner in which the terminal generates positioning intermediate data by using the AI positioning model; a third manner, where the third manner is a manner in which a third information reporting apparatus generates positioning result data by using the AI positioning model; a fourth manner, where the fourth manner is a manner in which an access network device generates positioning intermediate data by using an AI positioning model; or a fifth manner, where the fifth manner is a manner in which a third information reporting apparatus generates positioning result data by using the AI positioning model.

In a possible implementation, the second information reporting apparatus 50 provided in this embodiment of this application may further include: a receiving module, configured to: after the sending module 51 sends the first message to the first information reporting apparatus, receive an eighth message from the third information reporting apparatus, where the eighth message includes second related information for performing AI positioning via the second information reporting apparatus 50; and a processing module, configured to perform AI positioning based on the second related information included in the eighth message received by the receiving module.

In a possible implementation, the second related information includes at least one of the following: third indication information, where the third indication information is used to indicate to perform AI positioning; an AI positioning manner; a data type of measurement data to be reported; a data type of positioning intermediate data to be reported; or a data type of positioning result data to be reported.

In a possible implementation, the sending module 51 is further configured to: after the processing module performs AI positioning based on the second related information, send a ninth message to the third information reporting apparatus. The ninth message includes at least one of the following: first positioning data, where the first positioning data includes at least one of the following: positioning result data, positioning intermediate data, or measurement data; a data type corresponding to the first positioning data; an AI positioning manner for performing AI positioning; or fourth indication information, where the fourth indication information is used to indicate that the first positioning data is generated through AI positioning.

In a possible implementation, the first message is a registration message.

In a possible implementation, the second information reporting apparatus 50 provided in this embodiment of this application may further include: a receiving module, configured to: before the sending module 51 sends the first message to the first information reporting apparatus, receive a seventh message from the first information reporting apparatus. The seventh message is used to request the first related information. The sending module 51 is configured to send the first message to the first information reporting apparatus based on the seventh message received by the receiving module.

The second information reporting apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not limited in this embodiment of this application.

The second information reporting apparatus provided in this embodiment of this application can implement each process implemented in the method embodiment of FIG. 4, and achieve same technical effect. To avoid repetition, details are not described herein again.

FIG. 13 is a schematic diagram of a possible structure of an information reporting apparatus according to an embodiment of this application. The information reporting apparatus is a third information reporting apparatus. As shown in FIG. 13, the third information reporting apparatus 60 provided in this embodiment of this application may include: a receiving module 61, configured to receive a second message from a first information reporting apparatus, where the second message includes first related information corresponding to a second information reporting apparatus; and a positioning module 62, configured to perform, based on the first related information received by the receiving module 61, AI positioning via the second information reporting apparatus.

This embodiment of this application provides an information reporting apparatus, and the information reporting apparatus is the third information reporting apparatus. The first information reporting apparatus may send the second message to the third information reporting apparatus to indicate, to the third information reporting apparatus, the first related information corresponding to the second information reporting apparatus. In this way, the third information reporting apparatus may indicate, based on the first related information corresponding to the second information reporting apparatus, the second information reporting apparatus to perform AI positioning via the second information reporting apparatus in a positioning manner in which the second information reporting apparatus can perform AI positioning, instead of indicating the second information reporting apparatus to perform AI positioning via the second information reporting apparatus in a predetermined positioning manner. Therefore, this can reduce a probability that the second information reporting apparatus cannot perform AI positioning in a positioning manner, so that probability of a case in which the first information reporting apparatus cannot determine location information of a terminal can be reduced, and a probability of a case in which AI positioning fails to be performed can be reduced. In this way, a success rate of AI positioning can be improved.

In a possible implementation, the first related information includes at least one of the following: capability information, where the capability information is used to indicate an AI positioning capability corresponding to the second information reporting apparatus; or expected information, where the expected information is used to indicate a related manner expected by the second information reporting apparatus for performing AI positioning.

In a possible implementation, the capability information includes at least one of the following: first indication information, where the first indication information is used to indicate that the second information reporting apparatus supports AI positioning; an AI positioning manner supported by the second information reporting apparatus; an input data type supported by the second information reporting apparatus; an output data type supported by the second information reporting apparatus; a data type that the second information reporting apparatus supports for transmission; or a data type of measurement data supported by the second information reporting apparatus.

In a possible implementation, the expected information includes at least one of the following: an AI positioning manner expected by the second information reporting apparatus; an input data type expected by the second information reporting apparatus; an output data type expected by the second information reporting apparatus; a data type that the second information reporting apparatus expects to send; or a data type of measurement data expected by the second information reporting apparatus.

In a possible implementation, the AI positioning manner includes at least one of the following: a first manner, where the first manner is a manner in which a terminal generates positioning result data by using an AI positioning model; a second manner, where the second manner is a manner in which the terminal generates positioning intermediate data by using the AI positioning model; a third manner, where the third manner is a manner in which the third information reporting apparatus 60 generates positioning result data by using the AI positioning model; a fourth manner, where the fourth manner is a manner in which an access network device generates positioning intermediate data by using an AI positioning model; or a fifth manner, where the fifth manner is a manner in which the third information reporting apparatus 60 generates positioning result data by using the AI positioning model.

In a possible implementation, the third information reporting apparatus 60 provided in this embodiment of this application may further include: a determining module, configured to: After the receiving module 61 receives the second message from the first information reporting apparatus, determine, based on the first related information, second related information for performing AI positioning via the second information reporting apparatus.

In a possible implementation, the third information reporting apparatus 60 provided in this embodiment of this application may further include: a sending module, configured to: after the receiving module 61 receives the second message from the first information reporting apparatus, send an eighth message to the second information reporting apparatus. The eighth message includes the second related information for performing AI positioning via the second information reporting apparatus, and the eighth message is used to request to perform AI positioning based on the second related information.

In a possible implementation, the second related information includes at least one of the following: third indication information, where the third indication information is used to indicate to perform AI positioning; an AI positioning manner; a data type of measurement data to be reported; a data type of positioning intermediate data to be reported; or a data type of positioning result data to be reported.

In a possible implementation, the receiving module 61 is further configured to: after the sending module sends the eighth message to the second information reporting apparatus, receive a ninth message from the second information reporting apparatus. The ninth message includes at least one of the following: first positioning data, where the first positioning data includes at least one of the following: positioning result data, positioning intermediate data, or measurement data; a data type corresponding to the first positioning data; an AI positioning manner for performing AI positioning; or fourth indication information, where the fourth indication information is used to indicate that the first positioning data is generated through AI positioning.

In a possible implementation, the sending module is further configured to: after the receiving module 61 receives the ninth message from the second information reporting apparatus, send a third message to the first information reporting apparatus. The third message includes at least one of the following: first positioning result data; a data type corresponding to the first positioning result data; an AI positioning manner for performing AI positioning; or second indication information, where the second indication information is used to indicate that the first positioning result data is generated through AI positioning.

In a possible implementation, the third information reporting apparatus 60 provided in this embodiment of this application may further include: a sending module, configured to: before the receiving module 61 receives the second message from the first information reporting apparatus, send a seventh message to the second information reporting apparatus via the first information reporting apparatus. The seventh message is used to request the first related information.

The third information reporting apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the network side device 12, and the another device may be a server, a network attached storage (NAS), or the like. This is not limited in embodiments of this application.

The third information reporting apparatus provided in this embodiment of this application can implement each process implemented in the method embodiment of FIG. 5, and achieve same technical effect. To avoid repetition, details are not described herein again.

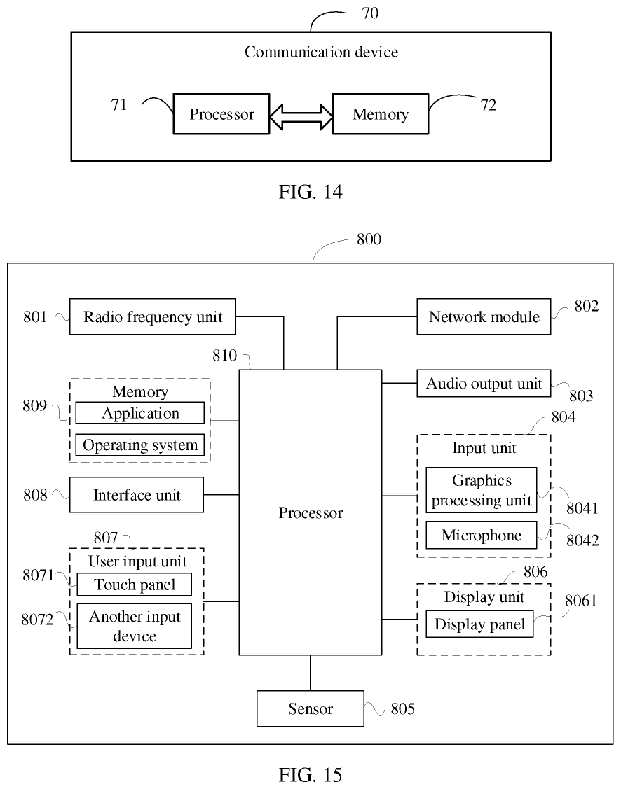

In some embodiments of this application, as shown in FIG. 14, an embodiment of this application further provides a communication device 70, including a processor 71 and a memory 72. The memory 72 stores a program or instructions executable on the processor 71. For example, when the communication device 70 is a terminal, and the program or the instructions are executed by the processor 71, the steps of the foregoing information reporting method embodiment are implemented, and same technical effect can be achieved. When the communication device 70 is a network side device, and the program or the instructions are executed by the processor 71, the steps of the foregoing information reporting method embodiment are implemented, and same technical effect can be achieved. To avoid repetition, details are not described herein again.

An embodiment of this application further provides a terminal, including a processor and a communication interface. The communication interface is coupled to the processor, and the processor is configured to run a program or instructions to implement the steps in the method embodiment shown in FIG. 4. The terminal embodiment corresponds to the method embodiment on the terminal side, each implementation process and implementation of the method embodiment can be applied to the terminal embodiment, and same technical effect can be achieved. Optionally, FIG. 15 is a schematic diagram of a hardware structure of a terminal according to an embodiment of this application.

The terminal 800 includes but is not limited to at least a part of components such as a radio frequency unit 801, a network module 802, an audio output unit 803, an input unit 804, a sensor 805, a display unit 806, a user input unit 807, an interface unit 808, a memory 809, and a processor 810.

It may be understood by a person skilled in the art that the terminal 800 may further include a power supply (for example, a battery) that supplies power to each component. The power supply may be logically connected to the processor 810 by using a power management system, so that functions such as charge and discharge management and power consumption management are implemented by using the power management system. The terminal structure shown in FIG. 15 constitutes no limitation on the terminal, and the terminal may include more or fewer components than those shown in the figure, or combine some components, or have different component arrangements. Details are not described herein.

It should be understood that in this embodiment of this application, the input unit 804 may include a graphics processing unit (GPU) 8041 and a microphone 8042. The graphics processing unit 8041 processes image data of a static picture or a video obtained by an image capture apparatus (for example, a camera) in a video capture mode or an image capture mode. The display unit 806 may include a display panel 8061, and the display panel 8061 may be configured in a form of a liquid crystal display, an organic light-emitting diode, or the like. The user input unit 807 includes at least one of a touch panel 8071 or another input device 8072. The touch panel 8071 is also referred to as a touchscreen. The touch panel 8071 may include two parts: a touch detection apparatus and a touch controller. The another input device 8072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 801 may transmit the downlink data to the processor 810 for processing. In addition, the radio frequency unit 801 may send uplink data to the network side device. Generally, the radio frequency unit 801 includes but is not limited to an antenna, an amplifier, a transceiver, a coupler, a low noise amplifier, a duplexer, and the like.

The memory 809 may be configured to store a software program or instructions and various data. The memory 809 may mainly include a first storage area for storing a program or instructions and a second storage area for storing data. The first storage area may store an operating system, and an application or instructions required by at least one function (for example, a sound playing function or an image playing function). The memory 809 may include a volatile memory or a non-volatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 809 in this embodiment of this application includes but is not limited to these memories and any memory of another proper type.

The processor 810 may include one or more processing units. Optionally, an application processor and a modem processor are integrated into the processor 810. The application processor mainly processes an operating system, a user interface, an application, and the like. The modem processor mainly processes a wireless communication signal, for example, a baseband processor. It may be understood that, alternatively, the modem processor may not be integrated into the processor 810.

The radio frequency unit 801 is configured to send a first message to a first communication device. The first message includes first related information corresponding to a second communication device. The first related information is used to perform AI positioning via the second communication device.

An embodiment of this application provides a terminal. The terminal may send the first message to the first communication device, to report, to the first communication device, the first related information used to perform AI positioning via the terminal. In this way, when AI positioning is performed via the terminal, the first communication device may determine, based on the first related information, a positioning manner for performing AI positioning via the terminal, to determine a positioning manner in which the terminal may perform AI positioning instead of using a predetermined positioning manner. Therefore, this can reduce a probability that the terminal cannot perform AI positioning in a positioning manner, so that probability of a case in which the first communication device cannot determine location information of the terminal can be reduced, and a probability of a case in which AI positioning fails to be performed can be reduced. In this way, a success rate of AI positioning can be improved.

It may be understood that for an implementation process of each implementation provided in this embodiment, refer to the related descriptions in the method embodiments, and corresponding technical effects can be achieved. To avoid duplication, details are not described herein again.

An embodiment of this application further provides a network side device, including a processor and a communication interface. The communication interface is coupled to the processor, and the processor is configured to run a program or instructions to implement the steps in the method embodiment shown in FIG. 3, FIG. 4, or FIG. 5. This network side device embodiment is corresponding to the foregoing method embodiment of the network side device. Each implementation process and implementation of the foregoing method embodiment may be applicable to this network side device embodiment, and a same technical effect can be achieved.

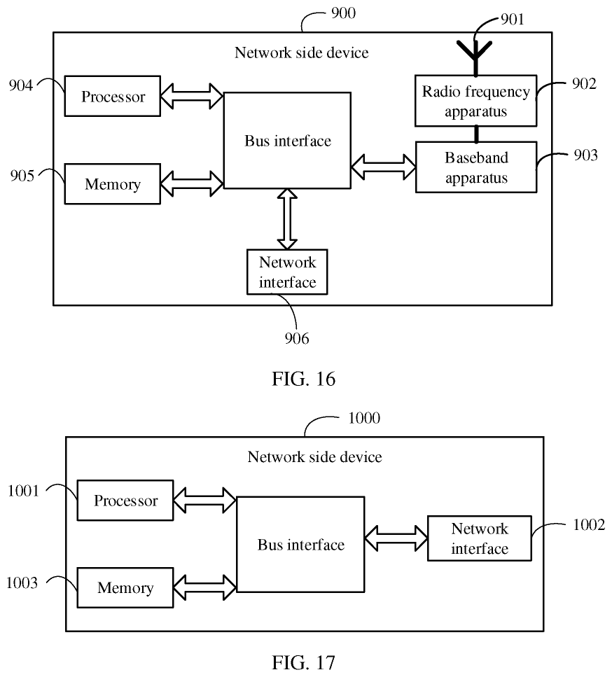

Optionally, an embodiment of this application further provides a network side device. As shown in FIG. 16, the network side device 900 includes an antenna 901, a radio frequency apparatus 902, a baseband apparatus 903, a processor 904, and a memory 905. The antenna 901 is connected to the radio frequency apparatus 902. In an uplink direction, the radio frequency apparatus 902 receives information through the antenna 901, and sends the received information to the baseband apparatus 903 for processing. In a downlink direction, the baseband apparatus 903 processes information that needs to be sent, and sends processed information to the radio frequency apparatus 902. The radio frequency apparatus 902 processes the received information, and sends processed information through the antenna 901.

In the foregoing embodiment, the method performed by the network side device may be implemented in the baseband apparatus 903. The baseband apparatus 903 includes a baseband processor.

For example, the baseband apparatus 903 may include at least one baseband board. A plurality of chips are disposed on the baseband board. As shown in FIG. 16, one chip is, for example, a baseband processor, and is connected to the memory 905 by using a bus interface, to invoke a program in the memory 905 to perform the operations of the network device shown in the foregoing method embodiment.

The network side device may further include a network interface 906, and the interface is, for example, a common public radio interface (CPRI).

Optionally, the network side device 900 in this embodiment of this application further includes instructions or a program, executable on the processor 904, that is stored in the memory 905. The processor 904 invokes the instructions or the program in the memory 905 to perform the method performed by the modules shown in FIG. 11 to FIG. 13, and same technical effect can be achieved. To avoid repetition, details are not described herein again.

Optionally, an embodiment of this application further provides a network side device. As shown in FIG. 17, a network side device 1000 includes a processor 1001, a network interface 1002, and a memory 1003. The network interface 1002 is, for example, a common public radio interface (CPRI).

Optionally, the network side device 1000 in this embodiment of this application further includes instructions or a program, executable on the processor 1001, that is stored in the memory 1003. The processor 1001 invokes the instructions or the program in the memory 1003 to perform the method performed by the modules shown in FIG. 11 to FIG. 13, and same technical effect can be achieved. To avoid repetition, details are not described herein again.

An embodiment of this application further provides a non-transitory readable storage medium. The non-transitory readable storage medium stores a program or instructions, and the program or the instructions are executed by a processor to implement each process of the foregoing information reporting method embodiment, and same technical effect can be achieved. To avoid repetition, details are not described herein again.

The processor is a processor in the terminal in the foregoing embodiments. The non-transitory readable storage medium includes a non-transitory computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor, and the processor is configured to run a program or instructions to implement each process of the foregoing information reporting method embodiment, and same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a non-transitory storage medium, and the computer program/program product is executed by at least one processor to implement each process of the foregoing information reporting method embodiment, and same technical effect can be achieved. To avoid repetition, details are not described herein again.

An embodiment of this application further provides a wireless communication system, including a first communication device, a second communication device, and a third communication device. The first communication device may be configured to perform the steps of the foregoing information reporting method, the second communication device may be configured to perform the steps of the foregoing information reporting method, and the third communication device may be configured to perform the steps of the foregoing information reporting method.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

According to the foregoing descriptions of the implementations, a person skilled in the art may clearly understand that the foregoing method embodiments may be implemented by using a computer software product and a required universal hardware platform, or certainly may be implemented by using hardware. The computer software product is stored in a non-transitory storage medium (such as a ROM, a RAM, a magnetic disk, or an optical disc), and includes several instructions for instructing a terminal or a network side device to perform the methods described in the embodiments of this application.

The foregoing describes embodiments of this application with reference to the accompanying drawings. However, this application is not limited to the foregoing implementations. The foregoing implementations are merely examples instead of limitations. Inspired by this application, a person of ordinary skill in the art may further make implementations in many forms without departing from the purposes of this application and the protection scope of the claims, and all the implementations shall fall within the protection of this application.

What is claimed is:

1. An information reporting method, comprising:
receiving, by a first communication device, a first message from a second communication device, wherein the first message comprises first related information corresponding to the second communication device; and
the first related information is used to perform artificial intelligence (AI) positioning via the second communication device.

2. The method according to claim 1, wherein the first related information comprises at least one of the following:
capability information, wherein the capability information is used to indicate an AI positioning capability corresponding to the second communication device; or
expected information, wherein the expected information is used to indicate a related manner expected by the second communication device for performing AI positioning.

3. The method according to claim 2, wherein the capability information comprises at least one of the following:
first indication information, wherein the first indication information is used to indicate that the second communication device supports AI positioning;
an AI positioning manner supported by the second communication device;
an input data type supported by the second communication device;
an output data type supported by the second communication device;
a data type that the second communication device supports for transmission; or
a data type of measurement data supported by the second communication device.

4. The method according to claim 2, wherein the expected information comprises at least one of the following:
an AI positioning manner expected by the second communication device;
an input data type expected by the second communication device;
an output data type expected by the second communication device;
a data type that the second communication device expects to send; or
a data type of measurement data expected by the second communication device.

5. The method according to claim 3, wherein the AI positioning manner comprises at least one of the following:
a first manner, wherein the first manner is a manner in which a terminal generates positioning result data by using an AI positioning model;
a second manner, wherein the second manner is a manner in which the terminal generates positioning intermediate data by using the AI positioning model;
a third manner, wherein the third manner is a manner in which a third communication device generates positioning result data by using the AI positioning model;
a fourth manner, wherein the fourth manner is a manner in which an access network device generates positioning intermediate data by using an AI positioning model; or
a fifth manner, wherein the fifth manner is a manner in which the third communication device generates positioning result data by using the AI positioning model.

6. The method according to claim 1, wherein after the receiving, by a first communication device, a first message from a second communication device, the method further comprises:
sending, by the first communication device, a second message to a third communication device, wherein the second message comprises the first related information.

7. The method according to claim 6, wherein after the sending, by the first communication device, a second message to a third communication device, the method further comprises:
receiving, by the first communication device, a third message from the third communication device, wherein the third message comprises at least one of the following:
first positioning result data;
a data type corresponding to the first positioning result data;
an AI positioning manner for performing AI positioning; or
second indication information, wherein the second indication information is used to indicate that the first positioning result data is generated through AI positioning.

8. The method according to claim 1, wherein the first message is a registration message.

9. An information reporting method, comprising:
sending, by a second communication device, a first message to a first communication device, wherein the first message comprises first related information corresponding to the second communication device; and
the first related information is used to perform artificial intelligence (AI) positioning via the second communication device.

10. The method according to claim 9, wherein the first related information comprises at least one of the following:
capability information, wherein the capability information is used to indicate an AI positioning capability corresponding to the second communication device; or
expected information, wherein the expected information is used to indicate a related manner expected by the second communication device for performing AI positioning.

11. The method according to claim 10, wherein the capability information comprises at least one of the following:
first indication information, wherein the first indication information is used to indicate that the second communication device supports AI positioning;
an AI positioning manner supported by the second communication device;
an input data type supported by the second communication device;
an output data type supported by the second communication device;
a data type that the second communication device supports for transmission; or
a data type of measurement data supported by the second communication device.

12. The method according to claim 9, wherein after the sending, by a second communication device, a first message to a first communication device, the method further comprises:
receiving, by the second communication device, an eighth message from a third communication device, wherein the eighth message comprises second related information for performing AI positioning via the second communication device; and
performing, by the second communication device, AI positioning based on the second related information;
wherein the second related information comprises at least one of the following:
third indication information, wherein the third indication information is used to indicate to perform AI positioning;
an AI positioning manner;
a data type of measurement data to be reported;
a data type of positioning intermediate data to be reported; or
a data type of positioning result data to be reported.

13. The method according to claim 12, wherein after the performing, by the second communication device, AI positioning based on the second related information, the method further comprises:
sending, by the second communication device, a ninth message to the third communication device, wherein the ninth message comprises at least one of the following:
first positioning data, wherein the first positioning data comprises at least one of the following: positioning result data, positioning intermediate data, or measurement data;
a data type corresponding to the first positioning data;
an AI positioning manner for performing AI positioning; or
fourth indication information, wherein the fourth indication information is used to indicate that the first positioning data is generated through AI positioning.

14. An information reporting method, comprising:
receiving, by a third communication device, a second message from a first communication device, wherein the second message comprises first related information corresponding to a second communication device; and
performing, by the third communication device, artificial intelligence (AI) positioning via the second communication device based on the first related information.

15. The method according to claim 14, wherein the first related information comprises at least one of the following:
capability information, wherein the capability information is used to indicate an AI positioning capability corresponding to the second communication device; or
expected information, wherein the expected information is used to indicate a related manner expected by the second communication device for performing AI positioning.

16. The method according to claim 15, wherein the capability information comprises at least one of the following:
first indication information, wherein the first indication information is used to indicate that the second communication device supports AI positioning;
an AI positioning manner supported by the second communication device;
an input data type supported by the second communication device;
an output data type supported by the second communication device;
a data type that the second communication device supports for transmission; or
a data type of measurement data supported by the second communication device.

17. The method according to claim 14, wherein after the receiving, by a third communication device, a second message from a first communication device, the method further comprises:
determining, by the third communication device based on the first related information, second related information for performing AI positioning via the second communication device.

18. The method according to claim 14, wherein after the receiving, by a third communication device, a second message from a first communication device, the method further comprises:
sending, by the third communication device, an eighth message to the second communication device, wherein the eighth message comprises second related information for performing AI positioning by using the second communication device, and the eighth message is used to request to perform AI positioning based on the second related information;
wherein the second related information comprises at least one of the following:
third indication information, wherein the third indication information is used to indicate to perform AI positioning;
an AI positioning manner;
a data type of measurement data to be reported;
a data type of positioning intermediate data to be reported; or
a data type of positioning result data to be reported.

19. The method according to claim 18, wherein after the sending, by the third communication device, an eighth message to the second communication device, the method further comprises:
receiving, by the third communication device, a ninth message from the second communication device, wherein the ninth message comprises at least one of the following:
first positioning data, wherein the first positioning data comprises at least one of the following: positioning result data, positioning intermediate data, or measurement data;
a data type corresponding to the first positioning data;
an AI positioning manner for performing AI positioning; or
fourth indication information, wherein the fourth indication information is used to indicate that the first positioning data is generated through AI positioning.

20. The method according to claim 19, wherein after the receiving, by the third communication device, a ninth message from the second communication device, the method further comprises:
sending, by the third communication device, a third message to the first communication device, wherein the third message comprises at least one of the following:
first positioning result data;
a data type corresponding to the first positioning result data;
an AI positioning manner for performing AI positioning; or
second indication information, wherein the second indication information is used to indicate that the first positioning result data is generated through AI positioning.
